(19) United States
(12) Patent Application Publication
(10) Pub. No.: US 2025/0244657 A1
(43) Pub. Date: Jul. 31, 2025

(54) PROJECTION SCREEN

(71) Applicant: LINTEC CORPORATION, Tokyo (JP)

(72) Inventors: Baku KATAGIRI, Tokyo (JP); Akihira WATANABE, Tokyo (JP); Hiroki FUKUSHIMA, Tokyo (JP); Tatsuki KURAMOTO, Tokyo (JP); Kentaro KUSAMA, Tokyo (JP)

(73) Assignee: LINTEC CORPORATION, Tokyo (JP)

(21) Appl. No.: 18/844,510

(22) PCT Filed: Feb. 9, 2023
(86) PCT No.: PCT/JP2023/004371

§ 371 Date: Apr. 11, 2025

(30) Foreign Application Priority Data
Mar. 9, 2022 (JP) 2022-036268
Mar. 29, 2022 (JP) 2022-054043

(51) Int. Cl. G03B 21/62; G02B 5/02

(52) U.S. Cl. CPC G03B 21/62; G02B 5/0242; G02B 5/0278

(57) ABSTRACT

A projection screen (1) comprising: a first light-scattering layer (11); a light diffusion control layer (10) laminated on one surface side of the first light-scattering layer (11), the light diffusion control layer (10) having a regular internal structure comprising a plurality of regions having a relatively high refractive index in a region having a relatively low refractive index; and a second light-scattering layer (12) laminated on a surface side of the light diffusion control layer (10) opposite to the first light-scattering layer (11). The projection screen (1) exhibits excellent visibility while suppressing unwanted reflection of images projected from the projector onto those other than the projection screen (1).

### TECHNICAL FIELD

The present invention relates to a projection screen.

### BACKGROUND ART

In recent years, projectors have been used to display images (including the concept of video) on projection screens. Among projection screens, as an example, a transmissive projection screen is becoming known. The transmissive projection screen displays an image projected from a projector to viewers who are on the opposite side of the projector across the transmissive projection screen.

In such a transmissive projection screen, after the light from the projector is focused on the screen to display an image, the light that passes through the screen may be focused on another location, such as on the ceiling or floor, and reflected to form an unwanted image.

In order to solve the problems as described above, Patent Documents 1 to 5 each disclose a transmissive projection screen that includes: a layer containing light-diffusing fine particles: and a light diffusion control layer having a regular internal structure. The regular internal structure includes a plurality of regions having a relatively high refractive index in a region having a relatively low refractive index.

### PRIOR ART DOCUMENTS

### Patent Documents

[Patent Document 1] JP2019-74730A
[Patent Document 2] JP2018-106138A
[Patent Document 3] JP2019-211612A
[Patent Document 4] JP2020-76894A
[Patent Document 5] JP2020-197659A

### SUMMARY OF THE INVENTION

### Problems to be Solved by the Invention

In the transmissive projection screens disclosed in Patent Documents 1 to 5, however, the visibility of the images formed on the screens are insufficient. Thus, further improvements in terms of the visibility are required.

The present invention has been made in view of such actual circumstances, and a first object of the present invention is to provide a projection screen that exhibits excellent visibility while suppressing unwanted reflection of images projected from the projector onto those other than the projection screen.

In addition, transmissive projection screens are generally required to display images with little blurring and high image sharpness. However, the transmissive projection screens disclosed in Patent Documents 1 to 5 are insufficient sharpness. Thus, further improvements in terms of image sharpness are required.

The present invention has been made in view of such actual circumstances, and a second object of the present invention is to provide a projection screen that can display images with high image sharpness while suppressing unwanted reflection of images projected from the projector onto those other than the projection screen.

### Means for Solving the Problems

To achieve the above first object, the present invention provides a projection screen comprising: a first light-scattering layer; a light diffusion control layer laminated on one surface side of the first light-scattering layer, the light diffusion control layer having a regular internal structure comprising a plurality of regions having a relatively high refractive index in a region having a relatively low refractive index; and a second light-scattering layer laminated on a surface side of the light diffusion control layer opposite to the first light-scattering layer (Invention 1).

In the above invention (Invention 1), at least one of the first light-scattering layer and the second light-scattering layer may preferably contain light-diffusing fine particles (Invention 2).

In the above invention or inventions (Inventions 1 and 2), the haze value of the projection screen may be preferably 1.0% or more and 80% or less (Invention 3).

In the above invention or inventions (Inventions 1 to 3), the total luminous transmittance of the projection screen may be preferably 60% or more and 100% or less (Invention 4).

TO achieve the above second object, the present invention provides a projection screen comprising: a third light-scattering layer; and a light diffusion control layer laminated on one surface side of the third light-scattering layer, the light diffusion control layer having a regular internal structure comprising a plurality of regions having a relatively high refractive index in a region having a relatively low refractive index, wherein the light diffusion control layer includes a structure-unformed layer in which the regular internal structure is not formed, and the structure-unformed layer has a thickness of 0 μm or more and 30 μm or less (Invention 5).

In the above invention (Invention 5), the third light-scattering layer may preferably contain light-diffusing fine particles (Invention 6).

In the above invention or inventions (Inventions 1 to 5), the regular internal structure may be preferably a louver structure configured such that a plurality of plate-like regions with different refractive indices are alternately arranged in any one direction along a sheet surface (Invention 7).

In the above invention (Invention 7), the louver structure is configured such that a longitudinal direction of the plate-like regions extends horizontally when the projection screen is installed vertically to a ground surface (Invention 8).

In the above invention or inventions (Inventions 1 to 8), the projection screen may be preferably a transmissive projection screen (Invention 9).

### Advantageous Effect of the Invention

The projection screen according to a first embodiment of the present invention exhibits excellent visibility while suppressing unwanted reflection of images projected from a projector onto those other than the projection screen.

The projection screen according to a second embodiment of the present invention can display images with high image sharpness while suppressing unwanted reflection of images projected from a projector onto those other than the projection screen.

### BRIEF DESCRIPTION OF DRAWINGS

FIG. 1 is a cross-sectional view illustrating a projection screen according to the first embodiment of the present invention.

FIG. 2 is a graph illustrating some of the results of Testing Example 1-3.

FIG. 3 is a graph illustrating some of the results of Testing Example 1-3.

FIG. 4 is a graph illustrating some of the results of Testing Example 1-3.

FIG. 5 is a graph illustrating some of the results of Testing Example 1-3.

FIG. 6 is a cross-sectional view illustrating a projection screen according to the second embodiment of the present invention.

FIG. 7 is a graph illustrating some of the results of Testing Example 2-1.

FIG. 8 is a graph illustrating some of the results of Testing Example 2-2.

FIG. 9 is a graph illustrating some of the results of Testing Example 2-3.

FIG. 10 is a graph illustrating some of the results of Testing Example 2-3.

### EMBODIMENTS FOR CARRYING OUT THE INVENTION

### First Embodiment

Hereinafter, the first embodiment of the present invention will be described.

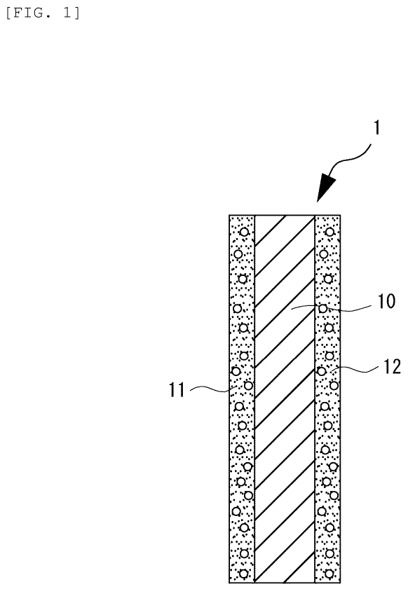

FIG. 1 illustrates a cross-sectional view of an example of a projection screen according to the first embodiment of the present invention. Projection screen 1 according to the present embodiment includes: a first light-scattering layer 11; a light diffusion control layer 10 that is laminated on one surface side of the first light-scattering layer 11 and that has a regular internal structure including a plurality of regions having a relatively high refractive index in a region having a relatively low refractive index; and a second light-scattering layer 12 laminated on a surface side of the light diffusion control layer 11 opposite to the first light-scattering layer 10.

The projection screen 1 according to the present embodiment has a configuration in which the light diffusion control layer 10 and the light-scattering layers (first light-scattering layer 11 and second light-scattering layer 12) are laminated together, and it is thereby possible to prevent the light projected from a projector from forming an image on those other than the projection screen (e.g., the ceiling, floor, etc.). That is, the projection screen 1 according to the present embodiment can suppress unwanted image reflection on the ceiling, floor, etc.

Furthermore, the projection screen 1 according to the present embodiment is configured such that two layers, the first light-scattering layer 11 and the second light-scattering layer 12, are disposed on both surface sides of the light diffusion control layer 10, and it is thereby possible to emit light projected from the projector in the forward direction with higher intensity than when there is only one light-scattering layer on one surface side. This allows the projection screen 1 according to the present embodiment to provide good visibility of the displayed image.

### 1. Light Diffusion Control Layer

The light diffusion control layer 10 in the present embodiment is not limited in its specific internal structure, composition, or the like, provided that it has a regular internal structure that includes a plurality of regions having a relatively high refractive index in a region having a relatively low refractive index.

### (1) Regular Internal Structure

The above-described regular internal structure refers to an internal structure configured such that a plurality of regions having a relatively high refractive index are arranged with a predetermined regularity in a region having a relatively low refractive index. For example, it refers to an internal structure configured such that, when viewing a cross section obtained by cutting the light diffusion control layer 10 along a plane parallel to the surface of the light diffusion control layer 10, the regions having a relatively high refractive index are repeatedly arranged at a similar pitch along at least one direction in the above cross section in the region having a relatively low index. Thus, the regular internal structure as referred to herein has a feature that the regions having a relatively high refractive index extend in the thickness direction of the light diffusion control layer 10, and this feature is distinguished from those of a phase-separation structure in which one phases exist in the other phase without clear regularity or a sea-island structure in which approximately spherical island components exist in a sea component.

According to the above regular internal structure, the incident light which is incident on the surface of the light diffusion control layer 10 within a predetermined incident angle range can exit the light diffusion control layer 10 while being strongly diffused with a predetermined opening angle (the incident angle range at this time may be referred to as an “incident light diffusion angle region”). On the other hand, when the incident light is at an angle that falls outside the above incident angle range, the incident light can transmit through the light diffusion control layer 10 without being diffused or exit the light diffusion control layer 10 with weaker diffusion than that in the case of the incident light within the incident angle range.

Specific examples of the above regular internal structure include a louver structure configured such that a plurality of plate-like regions with different refractive indices are alternately arranged in any one direction along a sheet surface. Another specific example is a column structure configured such that a plurality of columnar bodies having a relatively high refractive index are densely arranged to stand in a region having a relatively low refractive index. From the viewpoint of making it easier to suppress the unwanted image reflection and from the viewpoint of not unnecessarily increasing the haze in the front direction of the screen, the regular internal structure may be preferably a louver structure.

In the above louver structure, the direction perpendicular to the longitudinal direction in the above plate-like regions may be preferably tilted with respect to the thickness direction of the light diffusion control layer 10. In the above column structure, the above columnar bodies may be preferably tilted with respect to the thickness direction of the light diffusion control layer 10. These allow the projection screen 1 according to the present embodiment to readily suppress the unwanted image reflection.

The light diffusion control layer 10 in the present embodiment may have a structure other than the above-described louver structure and column structure. For example, the light diffusion control layer 10 may have, as the regular internal structure, a structure configured such that the columnar bodies in the above-described louver structure are bent at the middle in the thickness direction of the light diffusion control layer 10. The light diffusion control layer 10 may also have, as the regular internal structure, a structure in which the columnar bodies in the above-described column structure are bent at the middle in the thickness direction of the light diffusion control layer 10. Alternatively, the light diffusion control layer 10 may have a regular internal structure formed by laminating two or more of the louver structure, the column structure, and the above-described structures with bent portions in any combination.

### (2) Composition

From the viewpoint of readily forming the regular internal structure as described above, the composition of the light diffusion control layer 10 in the present embodiment may be preferably obtained by curing a composition for light diffusion control layer that contains a high refractive index component and a low refractive index component having a refractive index lower than that of the high refractive index component. In particular, each of the high refractive index component and the low refractive index component may preferably have one or two polymerizable functional groups.

### (2-1) High Refractive Index Component

Preferred examples of the above high refractive index component include (meth)acrylic ester that contains an aromatic ring, and (meth)acrylic ester that contains a plurality of aromatic rings may be particularly preferred. Examples of (meth)acrylic ester that contains a plurality of aromatic rings include those in which a part thereof is substituted with halogen, alkyl, alkoxy, alkyl halide, or the like, such as biphenyl (meth)acrylate, naphthyl (meth)acrylate, anthracyl (meth)acrylate, benzylphenyl (meth)acrylate, biphenyloxyalkyl (meth)acrylate, naphthyloxyalkyl (meth)acrylate, anthracyloxyalkyl (meth)acrylate, and benzylphenyloxyalkyl (meth)acrylate. Among these, biphenyl (meth)acrylate may be preferred from the viewpoint of readily forming a good regular internal structure. Specifically, o-phenylphenoxyethyl acrylate, o-phenylphenoxyethoxyethyl acrylate, or the like may be preferred. In the present specification, (meth)acrylic acid means both the acrylic acid and the methacrylic acid. The same applies to other similar terms.

The molecular weight (weight-average molecular weight) of the high refractive index component may be preferably 150 to 2,500, particularly preferably 200 to 1,500, and further preferably 250 to 1,000. When the molecular weight (weight-average molecular weight) of the high refractive index component is within the above range, the light diffusion control layer 10 having a desired regular internal structure can be readily formed. When the theoretical molecular weight of the above high refractive index component can be specified based on the molecular structure, the molecular weight (weight-average molecular weight) of the high refractive index component refers to the theoretical molecular weight (molecular weight that may not be the weight-average molecular weight). On the other hand, when it is difficult to specify the above-described theoretical molecular weight due to the above high refractive index component being a polymer component, for example, the molecular weight (weight-average molecular weight) of the high refractive index component refers to a weight-average molecular weight obtained as a standard polystyrene-equivalent value that is measured using a gel permeation chromatography (GPC) method. As used in the present specification, the weight-average molecular weight refers to a value that is measured as the standard polystyrene equivalent value using the GPC method.

The refractive index of the high refractive index component may be preferably 1.45 to 1.70, particularly preferably 1.50 to 1.65, and further preferably 1.56 to 1.59. When the refractive index of the high refractive index component is within the above range, the light diffusion control layer 10 having a desired regular internal structure can be readily formed. As used in the present specification, the refractive index means the refractive index of a certain component before curing the composition for light diffusion control layer, and the refractive index is measured in accordance with JIS K0062: 1992.

The content of the high refractive index component in the composition for light diffusion control layer may be preferably 25 to 400 mass parts, more preferably 40 to 300 mass parts, particularly preferably 80 to 250 mass parts, and further preferably 120 to 200 mass parts with respect to 100 mass parts of the low refractive index component. When the content of the high refractive index component is within such ranges, the regions derived from the high refractive index component and the region derived from the low refractive index component exist with a desired ratio in the regular internal structure of the light diffusion control layer 10 formed. As a result, the light diffusion control layer 10 having a desired regular internal structure can be readily formed.

### (2-2) Low Refractive Index Component

Preferred examples of the above low refractive index component include urethane (meth)acrylate, a (meth)acrylic-based polymer having a (meth)acryloyl group in a side chain, a (meth)acryloyl group-containing silicone resin, and an unsaturated polyester resin, but it may be particularly preferred to use urethane (meth)acrylate.

The above urethane (meth)acrylate may be preferably formed of (a) a compound that contains at least two isocyanate groups, (b) polyalkylene glycol, and (c) hydroxyalkyl (meth)acrylate.

Preferred examples of the above-described (a) compound that contains at least two isocyanate groups include aromatic polyisocyanates such as 2,4-tolylene diisocyanate, 2,6-tolylene diisocyanate, 1,3-xylylene diisocyanate, and 1,4-xylylene diisocyanate, aliphatic polyisocyanates such as hexamethylene diisocyanate, alicyclic polyisocyanates such as isophorone diisocyanate (IPDI) and hydrogenated diphenylmethane diisocyanate, biuret bodies and isocyanurate bodies thereof, and adduct bodies (e. g., a xylylene diisocyanate-based trifunctional adduct body) that are reaction products with low molecular active hydrogen-containing compounds such as ethylene glycol, propylene glycol, neopentyl glycol, trimethylol propane, and castor oil. Among these, an alicyclic polyisocyanate may be preferred, and an alicyclic diisocyanate that contains only two isocyanate groups may be particularly preferred.

Preferred examples of the above-described polyalkylene glycol include polyethylene glycol, polypropylene glycol, polybutylene glycol, and polyhexylene glycol, among which polypropylene glycol may be preferred.

The weight-average molecular weight of the (b) polyalkylene glycol may be preferably 2,300 to 19,500, particularly preferably 3,000 to 14,300, and further preferably 4,000 to 12,300.

Preferred examples of the above-described (c) hydroxyalkyl (meth)acrylate include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate.

Synthesis of the urethane (meth)acrylate using the above-described components (a) to (c) as the materials can be performed in a commonly-used method. In such a method, from the viewpoint of efficiently synthesizing the urethane (meth)acrylate, the compounding ratio of the components (a), (b), and (c) as the molar ratio may be preferably a ratio of 1-5:1:1-5 and particularly preferably a ratio of 1-3:1:1-3.

The weight-average molecular weight of the low refractive index component may be preferably 3,000 to 20,000, particularly preferably 5,000 to 15,000, and further preferably 7,000 to 13,000. When the weight-average molecular weight of the low refractive index component is within the above range, the light diffusion control layer 10 having a desired regular internal structure can be readily formed.

The refractive index of the low refractive index component may be preferably 1.30 to 1.59, more preferably 1.40 to 1.50, and particularly preferably 1.46 to 1.48. When the refractive index of the low refractive index component is within the above range, the light diffusion control layer 10 having a desired regular internal structure can be readily formed.

### (2-3) Other Components

The previously described composition for light diffusion control layer may contain other additives in addition to the high refractive index component and the low refractive index component. Examples of the other additives include a multifunctional monomer (compound having three or more polymerizable functional groups), a photopolymerization initiator, an antioxidant, an ultraviolet absorber, a light stabilizer, an antistatic, a polymerization accelerator, a polymerization inhibitor, an infrared absorber, a plasticizer, a diluting solvent, and a leveling agent.

The composition for light diffusion control layer may preferably contain a photopolymerization initiator among the above-described additives. When the composition for light diffusion control layer contains a photopolymerization initiator, the light diffusion control layer 10 having a desired regular internal structure can be readily and efficiently formed.

Examples of the photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl) ketone, benzophenone, p-phenylbenzophenone, 4,4-diethylaminobenzophenone, dichlorobenzophenone, 2-2-ethylanthraquinone, 2-tert-methylanthraquinone, butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminebenzoic ester, and oligo[2-hydroxy-2-methyl-1-[4-(1-methylvinyl)phenyl]propane]. These may each be used alone, or two or more types may also be used in combination.

When the photopolymerization initiator is used, the content of the photopolymerization initiator in the composition for light diffusion control layer may be preferably 0.2 to 20 mass parts, particularly preferably 0.5 to 15 mass parts, and further preferably 1 to 10 mass parts with respect to 100 mass parts of the total amount of the high refractive index component and the low refractive index component. When the content of the photopolymerization initiator in the composition for light diffusion control layer is within the above range, the light diffusion control layer 10 can be readily and efficiently formed.

### (2-4) Preparation of Composition for Light Diffusion Control Layer

The composition for light diffusion control layer can be prepared by uniformly mixing the previously described high refractive index component and low refractive index component and, if desired, other additives such as a photopolymerization initiator.

In the above mixing, a uniform composition for light diffusion control layer may be obtained by stirring it while heating it to a temperature of 40° C. to 80° C. A diluting solvent may be added and mixed so that the obtained composition for light diffusion control layer has a desired viscosity.

### (2-5) Method of Forming Light Diffusion Control Layer

The method of forming the light diffusion control layer 10 is not particularly limited, and the light diffusion control layer can be formed by a conventionally known method. For example, the previously described composition for light diffusion control layer may be prepared, and one surface of a process sheet may be coated with the composition to form a coating film. Preferably, the light diffusion control layer 10 can be formed by irradiating the above coating film with active energy rays to cure the coating film. Before or after the above irradiation with active energy rays, one surface (in particular, release surface) of a release sheet may be attached to the surface of the above coating film opposite to the process sheet, and the above coating film may be cured by irradiating the coating film with active energy rays through the process sheet or the release sheet.

Examples of the method for the above coating include a knife coating method, a roll coating method, a bar coating method, a blade coating method, a die coating method, and a gravure coating method. The composition for light diffusion control layer may be diluted using a solvent as necessary.

The above active energy rays refer to electromagnetic wave or charged particle radiation having an energy quantum, and specific examples of the active energy rays include ultraviolet rays and electron rays. Among the active energy rays, ultraviolet rays may be particularly preferred because of easy management.

When forming the previously described louver structure, a linear light source may be used as the light source for the active energy rays to irradiate the laminate surface with light randomly in the width direction (TD direction) and with approximately parallel strip-shaped (substantially linear) light in the flow direction (MD direction). The tilt angle of the plate-like regions formed in the louver structure can be adjusted by adjusting the irradiation angle of the above light.

When using ultraviolet rays as the active energy rays, the irradiation condition may be preferably set such that the peak illuminance on the coating film surface is 0.1 to 200 mW/cm². Additionally or alternatively, it may be preferred to set the integrated light amount on the coating film surface to 5 to 300 mJ/cm². Additionally or alternatively, the relative moving speed of the light source for the active energy rays with respect to the above laminate may be preferably set to 0.1 to 10 m/min.

From the viewpoint of completing more reliable curing, it may also be preferred to perform irradiation with commonly used active energy rays (active energy rays for which the process of converting the rays into strip-shaped light is not performed, scattered light) after performing the curing using the strip-shaped light as previously described. For this operation, a release sheet may be laminated on the coating film surface from the viewpoint of uniform curing.

### (2-6) Thickness of Light Diffusion Control Layer

The thickness of the light diffusion control layer 10 may be preferably 20 μm or more, more preferably 50 μm or more, particularly preferably 80 μm or more, and further preferably 120 μm or more. When the thickness of the light diffusion control layer 10 is 20 μm or more, the desired light diffusion properties can be readily exhibited. From another aspect, the thickness of the light diffusion control layer 10 may be preferably 700 μm or less, more preferably 500 μm or less, particularly preferably 300 μm or less, and further preferably 200 μm or less. When the thickness of the light diffusion control layer 10 is 700 μm or less, the occurrence of dents and/or collapse can be readily suppressed.

### 2. First Light-Scattering Layer and Second Light-Scattering Layer

The first light-scattering layer 11 and second light-scattering layer 12 in the present embodiment are not particularly limited in the configuration or composition, provided that they are layers having light diffusion properties. From the viewpoint of easily achieving the desired light diffusion properties and making the production of the projection screen 1 easier, at least one of the first light-scattering layer 11 and the second light-scattering layer 12 may be preferably a layer that contain light-diffusing fine particles, and more preferably a pressure sensitive adhesive layer that contains light-diffusing fine particles. In particular, in the projection screen 1 according to the present embodiment, it is preferred that both the first light-scattering layer 11 and the second light-scattering layer 12 are pressure sensitive adhesive layers that contain light-diffusing fine particles.

The pressure sensitive adhesive constituting the above pressure sensitive adhesive layer is not particularly limited, provided that it does not hinder the light diffusion action of the light-diffusing fine particles, and the pressure sensitive adhesive may be preferably one having transparency. It may also be preferred that the pressure sensitive adhesive can exhibit sufficient adhesive strength to maintain the layer structure of the projection screen 1. Specific examples of the above pressure sensitive adhesive include an acrylic-based pressure sensitive adhesive, a rubber-based pressure sensitive adhesive, a silicone-based pressure sensitive adhesive, a urethane-based pressure sensitive adhesive, a polyester-based pressure sensitive adhesive, and a polyvinyl ether-based pressure sensitive adhesive. Among these, an acrylic-based pressure sensitive adhesive may be preferably used from the viewpoint of readily exhibiting the desired performance.

When at least one of the first light-scattering layer 11 and the second light-scattering layer 12 is a pressure sensitive adhesive layer composed of an acrylic-based pressure sensitive adhesive, the pressure sensitive adhesive layer may be preferably formed of a pressure sensitive adhesive composition that contains at least light-diffusing fine particles, an acrylic-based polymer, and a crosslinker.

The first light-scattering layer 11 and the second light-scattering layer 12 may both have the same composition, or may also have different compositions.

### (1) Light-Diffusing Fine Particles

The above light-diffusing fine particles are not particularly limited, but preferred examples include inorganic fine particles, organic fine particles, silicone-based fine particles composed of a silicon-containing compound with an intermediate structure between inorganic and organic structures, such as silicone resin, (e.g., TOSPEARL series available from Momentive Performance Materials Japan), and hybrid fine particles of organic resins and silicone resins. One type of the light-diffusing fine particles may be used alone or two or more types may also be used in combination.

Examples of inorganic fine particles include metal oxides such as silica, aluminum oxide, zirconium oxide, titanium oxide, zinc oxide, germanium oxide, indium oxide, tin oxide, indium tin oxide (ITO), antimony oxide, and cerium oxide; and fine particles composed of metal fluorides and the like such as magnesium fluoride and sodium fluoride. Among the above, metal oxides may be preferred, titanium oxide or zinc oxide may be particularly preferred, and titanium oxide may be further preferred. The surfaces of the inorganic fine particles may be chemically modified with an organic compound or the like.

The shape of the inorganic fine particles may be any of a definite shape such as true spherical shape, an indefinite shape, etc., but from the viewpoint of efficiently exhibiting the light-diffusing properties with a small amount, the indefinite shape may be preferred.

The inorganic fine particles in the present embodiment may be preferably so-called nanoparticles. Specifically, the average particle diameter of the inorganic fine particles may be preferably 10 to 1,000 nm, more preferably 50 to 700 nm, particularly preferably 100 to 500 nm, and further preferably 200 to 300 nm. When the average particle diameter of the inorganic fine particles is within the above range, the previously described optical properties may be more readily satisfied. The average particle diameter of the inorganic fine particles is measured by a laser diffraction/scattering method.

The refractive index of the inorganic fine particles in the present embodiment may be preferably 1.8 to 3, particularly preferably 2 to 2.8, and further preferably 2.5 to 2.7. When the refractive index of the inorganic fine particles is within the above range, the previously described optical properties may be more readily satisfied. The refractive index of the light-diffusing fine particles can be measured, for example, by the following method. That is, a sample is prepared through placing fine particles on a slide glass, dropping a refractive index standard solution onto the fine particles, and covering the fine particles with a cover glass. The sample is observed with a microscope, and the refractive index of the refractive index standard solution at which the outline of the fine particles becomes most difficult to see may be determined as the refractive index of the fine particles.

Examples of organic fine particles include those of acrylic resin, polystyrene resin, polyethylene resin, epoxy resin, and their copolymers or mixtures.

The shape of organic fine particles, silicone-based fine particles, and hybrid fine particles may be preferably spherical fine particles with uniform light diffusion. The average particle diameter of these fine particles measured by the centrifugal sedimentation light transmission method may be preferably 0.1 to 20 μm and more preferably 1 to 10 μm. When the average particle diameter of the above fine particles is within the above range, the previously described optical properties are more likely to be satisfied.

The average particle diameter measured by the above centrifugal sedimentation light transmission method may be measured using a centrifugal automatic particle size distribution analyzer (available from Horiba, Ltd., CAPA-700) for a sample for measurement prepared by sufficiently mixing 1.2 g of fine particles and 98.8 g of isopropyl alcohol.

When the pressure sensitive adhesive composition contains light-diffusing fine particles and an acrylic-based polymer, the content of the light-diffusing fine particles in the pressure sensitive adhesive composition may be preferably 0.01 to 5 mass parts, more preferably 0.05 to 2 mass parts, particularly preferably 0.1 to 1 mass part, and further preferably 0.2 to 0.6 mass parts with respect to 100 mass parts of the acrylic-based polymer. When the content of the light-diffusing fine particles is within the above range, it becomes easier to achieve the desired light diffusion properties, and the projection screen 1 according to the present embodiment can have more excellent visibility.

### (2) Acrylic-Based Polymer

The monomer units constituting the above acrylic-based polymer can be appropriately adjusted from the viewpoints of transparency, adhesive strength, etc., but the monomer units may preferably contain a (meth)acrylic alkyl ester and a monomer having a reactive functional group in the molecule (reactive functional group-containing monomer). In the present specification, (meth)acrylic acid means both the acrylic acid and the methacrylic acid. The same applies to other similar terms. Furthermore, the term “polymer” encompasses the concept of a “copolymer.”

The acrylic-based polymer may contain (meth)acrylic alkyl ester as a monomer unit that constitutes the polymer, and can thereby develop good pressure sensitive adhesive properties. As the (meth)acrylic alkyl ester, a (meth)acrylic alkyl ester whose carbon number of alkyl group is 1 to 20 may be preferred. The alkyl group may be linear or branched and may also have a cyclic structure.

Examples of the (meth)acrylic alkyl ester whose carbon number of alkyl group is 1 to 20 include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, stearyl (meth)acrylate, cyclohexyl (meth)acrylate, isobornyl (meth)acrylate, and adamantyl (meth)acrylate. These may each be used alone or two or more types may also be used in combination.

The above acrylic-based polymer may preferably contain 20 to 95 mass %, particularly preferably 40 to 90 mass %, and further preferably 60 to 85 mass % of the (meth)acrylic alkyl ester as a monomer unit that constitutes the polymer. Within these ranges, a desired adhesive strength can be readily achieved.

The above acrylic-based polymer may contain a reactive functional group-containing monomer as a monomer unit that constitutes the polymer. When containing a reactive functional group-containing monomer, the acrylic-based polymer reacts with a crosslinker, which will be described later, via the reactive functional group derived from the reactive functional group-containing monomer, thereby forming a crosslinked structure (three-dimensional network structure). Thus, a pressure sensitive adhesive having a desired cohesive strength can be obtained.

Preferred examples of the above reactive functional group-containing monomer include a monomer having a hydroxy group in the molecule (hydroxy group-containing monomer), a monomer having a carboxy group in the molecule (carboxy group-containing monomer), and a monomer having an amino group in the molecule (amino group-containing monomer). These reactive functional group-containing monomers may each be used alone or two or more types may also be used in combination.

Among the above reactive functional group-containing monomers, from the viewpoint of easily adjusting the crosslink density and easily obtaining a pressure sensitive adhesive having a desired cohesive strength, a hydroxy group-containing monomer or a carboxy group-containing monomer may be preferred, and from the viewpoint of adhesive strength, it is preferred to use a hydroxy group-containing monomer and a carboxy group-containing monomer in combination.

Examples of the hydroxy group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Among the above, hydroxyalkyl (meth)acrylates whose carbon number is 1 to 4 may be preferred. Specifically, for example, 2-hydroxyethyl (meth)acrylate, 4-hydroxybutyl (meth)acrylate, etc. may be preferred, and 2-hydroxyethyl acrylate or 4-hydroxybutyl acrylate may be particularly preferred. These may each be used alone or two or more types may also be used in combination.

Examples of the carboxy group-containing monomer include ethylenically unsaturated carboxylic acids such as acrylic acid, methacrylic acid, crotonic acid, maleic acid, itaconic acid, and citraconic acid. Among these, acrylic acid may be preferred from the viewpoint of the cohesive strength of a (meth)acrylic ester polymer (A) obtained. These may each be used alone or two or more types may also be used in combination.

The above acrylic-based polymer preferably contains 0.1 to 20 mass %, more preferably 0.3 to 10 mass %, particularly preferably 0.5 to 5 mass %, and further preferably 0.8 to 3 mass % of the reactive functional group-containing monomer as a monomer unit that constitutes the polymer. Within these ranges, the acrylic-based polymer is more likely to undergo a desired crosslinking reaction with a crosslinked, and as a result, the obtained pressure sensitive adhesive is more likely to have good cohesive strength.

The acrylic-based polymer in the present embodiment may further contain other monomers as monomers that constitute the polymer. Examples of the other monomers include alicyclic structure-containing (meth)acrylic esters such as dicyclopentanyl (meth)acrylate, adamantyl (meth)acrylate, isobornyl (meth)acrylate, dicyclopentenyl (meth)acrylate, and dicyclopentenyl oxyethyl (meth)acrylate; (meth)acrylic alkoxyalkyl esters such as methoxyethyl (meth)acrylate and ethoxyethyl (meth)acrylate; non-crosslinkable acrylamides such as acrylamide and methacrylamide; (meth)acrylic esters having non-crosslinkable tertiary amino groups, such as N,N-dimethylaminoethyl (meth)acrylate and N,N-dimethylaminopropyl (meth)acrylate; vinyl acetate and styrene. Among these, vinyl acetate may be preferred from the viewpoint of the cohesive strength of the (meth)acrylic ester polymer (A) obtained. These may each be used alone or two or more types may also be used in combination.

The above acrylic-based polymer may preferably contain 1 to 30 mass %, particularly preferably 10 to 25 mass %, and further preferably 15 to 20 mass % of other monomers as monomer units that constitute the polymer. This allows the obtained pressure sensitive adhesive to readily have good cohesive strength.

The polymerization form of the acrylic-based polymer in the present embodiment may be a random polymer or may also be a block polymer. The acrylic-based polymer can be obtained by polymerizing any of the above-described monomers using an ordinary method. For example, the acrylic-based polymer can be prepared by polymerization, such as using an emulsion polymerization method, a solution polymerization method, a suspension polymerization method, a bulk polymerization method, or an aqueous solution polymerization method. Among these, the solution polymerization method performed in an organic solvent may be preferably adopted for preparing the acrylic-based polymer from the viewpoint of stability during polymerization and ease of handling during use.

The weight-average molecular weight of the acrylic-based polymer may be preferably 100,000 to 5,000,000, more preferably 200,000 to 2,000,000, particularly preferably 500,000 to 1,500,000, and further preferably 700,000 to 1,000,000. This allows the acrylic-based polymer to have good dispersibility of the above-described light-diffusing fine particles, and the obtained pressure sensitive adhesive can readily exhibit the desired adhesive properties and optical properties.

The pressure sensitive adhesive composition according to the present embodiment may contain one type or two or more types of the above-described acrylic-based polymer. In addition, the pressure sensitive adhesive composition according to the present embodiment may contain another acrylic-based polymer together with the above-described acrylic-based polymer.

### (3) Crosslinker

The crosslinker crosslinks the above-described acrylic-based polymer due to heating of the pressure sensitive adhesive composition and can well form a three-dimensional network structure. This allows the obtained pressure sensitive adhesive to have an improved cohesive strength.

Preferred examples of the above crosslinker include those reacting with a reactive functional group of the acrylic-based polymer. Such examples include an isocyanate-based crosslinker, an epoxy-based crosslinker, an amine-based crosslinker, a melamine-based crosslinker, an aziridine-based crosslinker, a hydrazine-based crosslinker, an aldehyde-based crosslinker, an oxazoline-based crosslinker, a metal alkoxide-based crosslinker, a metal chelate-based crosslinker, a metal salt-based crosslinker, and an ammonium salt-based crosslinker.

When the reactive group of the acrylic-based polymer is a hydroxy group, it may be preferred to use, among the above-described examples of crosslinkers, an isocyanate-based crosslinker having excellent reactivity with the hydroxy group. When the reactive group of the acrylic-based polymer is a carboxy group, it may be preferred to use an epoxy-based crosslinker having excellent reactivity with the carboxy group. One type of the crosslinker may be used alone or two or more types may also be used in combination.

The isocyanate-based crosslinker contains at least a polyisocyanate compound. Examples of the polyisocyanate compound include aromatic polyisocyanates such as tolylene diisocyanate, diphenylmethane diisocyanate and xylylene diisocyanate, aliphatic polyisocyanates such as hexamethylene diisocyanate, alicyclic polyisocyanates such as isophorone diisocyanate and hydrogenated diphenylmethane diisocyanate, biuret bodies and isocyanurate bodies thereof, and adduct bodies that are reaction products with low molecular active hydrogen-containing compounds such as ethylene glycol, propylene glycol, neopentyl glycol, trimethylol propane, and castor oil. Among these, trimethylolpropane-modified aromatic polyisocyanate may be preferably used from the viewpoint of reactivity with a hydroxy group. In particular, at least one of trimethylolpropane-modified tolylene diisocyanate and trimethylolpropane-modified xylylene diisocyanate may be preferably used. From the viewpoint of weather resistance, it may be preferred to use an aliphatic polyisocyanate such as hexamethylene diisocyanate.

Examples of epoxy crosslinkers include 1,3-bis(N,N-diglycidylaminomethyl) cyclohexane, N,N,N′,N′-tetraglycidyl-m-xylylenediamine, ethylene glycol diglycidyl ether, 1,6-hexanediol diglycidyl ether, trimethylolpropane diglycidyl ether, diglycidylaniline, and diglycidylamine. Among these, 1,3-bis(N,N-diglycidylaminomethyl)cyclohexane may be preferred from the viewpoint of reactivity with a carboxy group.

When the pressure sensitive adhesive composition contains a crosslinker and an acrylic-based polymer, the content of the crosslinker in the pressure sensitive adhesive composition may be preferably 0.01 to 5 mass parts, particularly preferably 0.1 to 2 mass parts, and further preferably 0.2 to 1 mass part with respect to 100 mass parts of the acrylic-based polymer. When the content of the crosslinker is within the above range, the obtained pressure sensitive adhesive can exhibit more excellent cohesive strength.

### (4) Various Additives

If desired, the pressure sensitive adhesive composition can contain one or more of various additives, such as a silane coupling agent, an anticorrosive, an ultraviolet absorber, a tackifier, an antioxidant, a light stabilizer, a softening agent, and a refractive index adjuster, which are commonly used in an acrylic-based pressure sensitive adhesive. The additives which constitute the pressure sensitive adhesive composition are deemed not to include a polymerization solvent or a diluent solvent, which will be described later.

### (5) Method of Preparing Pressure Sensitive Adhesive Composition

The pressure sensitive adhesive composition can be prepared through preparing the acrylic-based polymer, mixing the prepared acrylic-based polymer with light-diffusing fine particles and crosslinker and, if desired, adding additives, etc.

The acrylic-based polymer can be prepared by polymerizing a mixture of the monomers which constitute the polymer using a commonly-used radical polymerization method. Polymerization of the acrylic-based polymer may be preferably carried out by a solution polymerization method, if desired, using a polymerization initiator. However, the polymerization method is not limited to this, and polymerization may be carried out without a solvent. Examples of the polymerization solvent include ethyl acetate, n-butyl acetate, isobutyl acetate, toluene, acetone, hexane, and methyl ethyl ketone, and two or more types thereof may also be used in combination.

After the acrylic-based polymer is obtained, the pressure sensitive adhesive composition (coating solution) diluted with a solvent may be obtained through adding the light-diffusing fine particles and crosslinker, and if desired, a diluting solvent, additives, etc. to the solution of the acrylic-based polymer and sufficiently mixing them. If any of the above components is in the form of a solid, or if precipitation occurs when the component is mixed with another component in an undiluted state, the component may be preliminarily dissolved in or diluted with a diluting solvent alone and then mixed with other components.

Examples of the above diluting solvent for use include aliphatic hydrocarbons such as hexane, heptane and as toluene and cyclohexane, aromatic hydrocarbons such xylene, halogenated hydrocarbons such as methylene chloride and ethylene chloride, alcohols such as methanol, ethanol, propanol, butanol and 1-methoxy-2-propanol, ketones such as acetone, methyl ethyl ketone, 2-pentanone, isophorone and cyclohexanone, esters such as ethyl acetate and butyl acetate, and cellosolve-based solvents such as ethyl cellosolve.

The concentration/viscosity of the coating solution thus prepared is not particularly limited and can be appropriately selected depending on the situation, provided that the concentration/viscosity is within any range in which the coating is possible. For example, the pressure sensitive adhesive composition may be diluted to a concentration of 10 to 60 mass %. When obtaining the coating solution, the addition of a diluting solvent or the like is not a necessary condition, and the diluting solvent may not be added if the pressure sensitive adhesive composition has a viscosity or the like that enables the coating. In this case, the pressure sensitive adhesive composition may be a coating solution in which the polymerization solvent itself for the acrylic-based polymer is used as a diluting solvent.

### (6) Physical Properties, Etc. (Thickness, Haze Value, Total Luminous Transmittance)

The haze value of a laminate including the first light-scattering layer 11 and the second light-scattering layer 12 in the present embodiment may be preferably 1% or more, more preferably 5% or more, particularly preferably 10% or more, further preferably 20% or more, and especially preferably 30% or more. This can readily and effectively suppress the unwanted image reflection on those other than the projection screen 1. From another aspect, the haze value may be preferably 80% or less, more preferably 60% or less, particularly preferably 50% or less, and further preferably 40% or less. This can improve the light transmittance, and the projection screen 1 according to the present embodiment can have more excellent visibility.

In the present embodiment, total luminous the transmittance of each of the first light-scattering layer 11 and the second light-scattering layer 12 may be preferably 60% or more, particularly preferably 70% or more, and further preferably 80% or more. When the total luminous transmittance of each of the first light-scattering layer 11 and the second light-scattering layer 12 is 60% or more, the projection screen 1 according to the present embodiment can have more excellent visibility. From another aspect, the total luminous transmittance may be preferably 100% or less, particularly preferably 98% or less, and further preferably 95% or less. When the total luminous transmittance of each of the first light-scattering layer 11 and the second light-scattering layer 12 is 100% or less, the above-described haze value can be readily achieved.

The thicknesses of the first light-scattering layer 11 and second light-scattering layer 12 in the present embodiment may be preferably 1 to 200 μm, more preferably 2 to 120 μm, particularly preferably 5 to 60 μm, further preferably 10 to 30 μm, especially preferably 11 to 20 μm, and most preferably 12 to 15 μm. When the thicknesses of the first light-scattering layer 11 and second light-scattering layer 12 in the present embodiment are within the above ranges, both the effect of suppressing the unwanted reflection and the excellent visibility can be readily achieved at a high level.

### 3. Other Configurations

The projection screen 1 according to the present embodiment may include one or more members other than the light diffusion control layer 10, the first light-scattering layer 11, and the second light-scattering layer 12. For example, the projection screen 1 may include at least one transparent base material. In particular, when at least one of the first light-scattering layer 11 and the second light-scattering layer 12 is the previously described pressure sensitive adhesive layer, a transparent base material may be preferably laminated on at least one surface of the pressure sensitive adhesive layer (in particular, the surface on the outermost layer side).

Examples of the above transparent base material include a plastic film, a plastic plate, and a glass plate. When process sheets or release sheets are used upon formation of the light diffusion control layer 10, the first light-scattering layer 11, and the second light-scattering layer 12, these may be used as the above transparent base materials.

Examples of the above plastic film include films of polyesters such as polyethylene terephthalate, polybutylene terephthalate, and polyethylene naphthalate, polyolefin films such as polyethylene films and polypropylene films, cellophane, diacetyl cellulose films, triacetyl cellulose films, acetyl cellulose butyrate films, polyvinyl chloride films, polyvinylidene chloride films, polyvinyl alcohol films, ethylene-vinyl acetate copolymer films, polystyrene films, polycarbonate films, polymethylpentene films, polysulfone films, polyetheretherketone films, polyethersulfone films, polyether imide films, fluororesin films, polyamide films, acrylic resin films, polyurethane resin films, norbornene-based polymer films, cyclic olefin-based polymer films, cyclic conjugated diene-based polymer films, vinyl alicyclic hydrocarbon polymer films, other similar plastic films, and laminated films thereof. Among these, polyethylene terephthalate films, polycarbonate films, or the like may be preferred from the viewpoint of transparency, mechanical strength, etc.

The thickness of the above plastic film may be preferably 10 to 200 μm, more preferably 15 to 150 μm, particularly preferably 20 to 100 μm, and further preferably 25 to 80 μm from the viewpoint of handling properties, transparency, mechanical strength, etc.

Examples of the above plastic plate include, but are not limited to, acrylic plates and polycarbonate plates. The thickness of the plastic plate is not particularly limited, but may be usually 0.2 to 10 mm, preferably 0.3 to 5 mm, and more preferably 0.5 to 3 mm.

Examples of the above glass plate include, but are not limited to, chemically strengthened glass, alkali-free glass, quartz glass, soda lime glass, barium/strontium-containing glass, aluminosilicate glass, lead glass, borosilicate glass, and barium borosilicate glass. The thickness of the glass plate is not particularly limited, but may be usually 0.1 to 10 mm, preferably 0.15 to 5 mm, and more preferably 0.2 to 3 mm.

The projection screen 1 according to the present embodiment may also include a light-transmitting member. Examples of the light-transmitting member include transparent hard plates such as glass plates and plastic plates and flexible transparent bodies such as plastic films. More specifically, examples of the light-transmitting member include, but are not limited to, glass in illustrate windows; glass in buildings such as window glass, glass in exterior walls, and glass in partitions; glass installed in event venues; and window glass in various vehicles.

### 4. Physical Properties of Projection Screen

The haze value of the projection screen 1 according to the present embodiment may be preferably 1% or more, more preferably 2% or more, particularly preferably 5% or more, and further preferably 10% or more. This can readily and effectively suppress the unwanted image reflection on those other than the projection screen 1. From another aspect, the haze value may be preferably 80% or less, more preferably 60% or less, particularly preferably 50% or less, and further preferably 40% or less. This can improve the light transmittance, and more excellent visibility can be obtained.

Total luminous transmittance T.T of the projection screen 1 according to the present embodiment may be preferably 60% or more and 100% or less from the viewpoint of visibility. This allows the visibility and the above-described haze value of the projection screen 1 to be readily achieved. From such a viewpoint, the total luminous transmittance T.T may be preferably 65% to 99%, particularly preferably 70% to 95%, preferably 75% to 90%, and further preferably 78% to 85%.

In the projection screen 1 according to the present embodiment, parallel component P.T may be preferably 1% to 99%, more preferably 10% to 80%, particularly preferably 40% to 60%, and further preferably 45% to 55% from the viewpoint of improving the background visibility through the screen.

In the projection screen 1 according to the present embodiment, diffuse component Dif. may be preferably 1% to 99%, more preferably 10% to 70%, particularly preferably 20% to 40%, and further preferably 25% to 35% from the viewpoint of improving the visibility of the image projected on the screen.

### 5. Method of Producing Projection Screen

The method of producing the projection screen 1 according to the present embodiment is not particularly limited. For example, the projection screen 1 can be obtained through separately forming the light diffusion control layer 10, the first light-scattering layer 11, and the second light-scattering layer 12 and then laminating them so that the light diffusion control layer 10 is disposed between the first light-scattering layer 11 and the second light-scattering layer 12.

When the light diffusion control layer 10 is formed in a state in which process sheets or release sheets are laminated thereon, it may be laminated on the first light-scattering layer 11 and the second light-scattering layer 12 after removing these sheets, or it may be laminated on the first light-scattering layer 11 and the second light-scattering layer 12 while these sheets are attached.

When at least one of the first light-scattering layer 11 and the second light-scattering layer 12 is a pressure sensitive adhesive layer, one surface of a process sheet or the release surface of a release sheet may be coated with the coating solution of the previously described pressure sensitive adhesive composition, and a heat treatment is performed to thermally crosslink the pressure sensitive adhesive composition to form a coating layer. Then, by providing an aging period as necessary, the coating layer can be made into a pressure sensitive adhesive layer (light-scattering layer). The surface on the light-scattering layer side of the laminate of the process sheet or release sheet and the light-scattering layer obtained in this way may be attached to one surface side of the light diffusion control layer 10, and the projection screen 1 can thereby be obtained.

### 6. Method of Using Projection Screen

The projection screen 1 according to the present embodiment can be used in the same way as an ordinary projection screen, and may be particularly suitable for use as a transmissive projection screen.

When the projection screen 1 is used as a transmissive projection screen, a projector may be placed at a position on the opposite side of the viewer across the projection screen 1. In this case, from the viewpoint of avoiding excessive light being directed toward the viewer, it may be preferred to place the projector at a position at which light is emitted obliquely onto the projection screen (in particular, a position diagonally above or below the projection screen).

When the light diffusion control layer 10 has the previously described louver structure as the regular internal structure, it may be preferred to place the projection screen 1 so that when the projection screen 1 according to the present embodiment is installed vertically to the ground surface, the longitudinal direction of the plate-like regions extends horizontally. This may make it easier to effectively transmit the light emitted obliquely onto the projection screen 1 in the forward direction.

### Second Embodiment

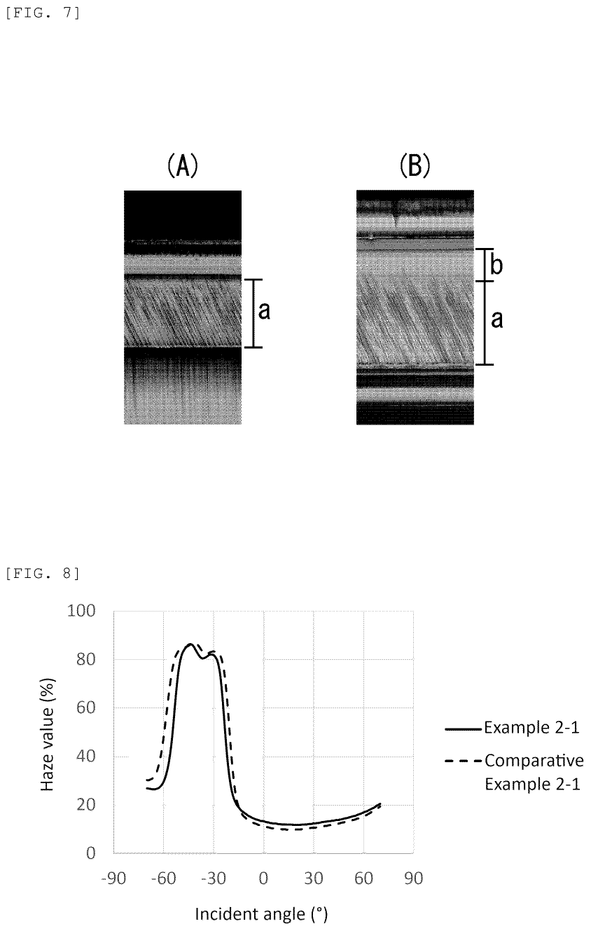

FIG. 6 illustrates a cross-sectional view of an example of a projection screen according to the second embodiment of the present invention. Projection screen 2 according to the present embodiment includes: a third light-scattering layer 21; and a light diffusion control layer 20 that is laminated on one surface side of the third light-scattering layer 21 and that has a regular internal structure including a plurality of regions having a relatively high refractive index in a region having a relatively low refractive index.

The projection screen 2 according to the present embodiment has a configuration in which the light diffusion control layer 20 and the third light-scattering layer 21 are laminated together, and it is thereby possible to prevent the light projected from a projector from forming an image on those other than the projection screen (e.g., the ceiling, floor, etc.). That is, the projection screen 2 according to the present embodiment can suppress unwanted image reflection on the ceiling, floor, etc.

In the projection screen 2 according to the present embodiment, the light diffusion control layer 20 includes a structure-unformed layer in which the above regular internal structure is not formed, and the thickness of the structure-unformed layer is 0 μm or more and 30 μm or less. Thus, the light diffusion control layer 20 has no or almost no structure-unformed layer, and the entire thickness of the light diffusion control layer 20 can thereby exhibit its action of light diffusion control. This allows the projection screen 2 according to the present embodiment to display images with less blurring and high image sharpness.

When the light diffusion control layer 20 has a structure-unformed layer (i.e., when the thickness of the structure-unformed layer exceeds 0 μm), the thickness of the structure-unformed layer may be preferably 20 μm or less, more preferably 10 μm or less, particularly preferably 5 μm or less, and further preferably 1 μm or less from the viewpoint of facilitating achievement of higher image sharpness.

### 1. Light Diffusion Control Layer

The light diffusion control layer 20 in the present embodiment is not limited in its specific internal structure, composition, or the like, provided that it has a regular internal structure that includes a plurality of regions having a relatively high refractive index in a region having a relatively low refractive index and it satisfies the above conditions regarding the thickness of the structure-unformed layer.

In conventional projection screens, it has been difficult to avoid the occurrence of a structure-unformed layer when forming the above-described regular internal structure in a conventional light diffusion control layer used to suppress the unwanted image reflection. Therefore, conventional light diffusion control layers used to suppress the unwanted image reflection include a structure-unformed layer with a certain thickness. Fortunately, however, the light diffusion control layer 20 according to the present embodiment does not have a structure-unformed layer, or has a structure-unformed layer only with the previously described thickness.

### (1) Regular Internal Structure

Preferred aspects of the regular internal structure of the light diffusion control layer 20 according to the second embodiment may be the same as the content which has been previously described as the preferred aspects of the regular internal structure of the light diffusion control layer 10 according to the first embodiment.

### (2) Composition

Among the preferred aspects of the composition of the light diffusion control layer 20 according to the second embodiment, “(2-1) High Refractive Index Component,” “(2-2) Low Refractive Index Component,” “(2-3) Other Components,” and “(2-4) Preparation of Composition for Light Diffusion Control Layer” may be the same as the content which has been previously described as the preferred aspects of the composition of the light diffusion control layer 10 according to the first embodiment.

### (2-5) Method of Forming Light Diffusion Control Layer

The light diffusion control layer 20 can be formed by a conventionally known method. For example, the previously described composition for light diffusion control layer may be prepared, and one surface of a process sheet or release sheet (which may be referred to as a “first process sheet” or “first release sheet,” hereinafter) may be coated with the composition to form a coating film. Preferably, the light diffusion control layer 10 can be formed through attaching another process sheet or release sheet (which may be referred to as a “second process sheet” or “second release sheet,” hereinafter) to the surface of the above coating film opposite to the process sheet and irradiating the above coating film with active energy rays through the first process sheet or the second process sheet to cure the coating film. Alternatively, instead of attaching the above second process sheet, the coating film may be irradiated with active energy rays in a nitrogen atmosphere to cure the coating film. From the viewpoint of readily obtaining the light diffusion control layer 20 having no or almost no structure-unformed layer, the former method of forming the light diffusion control layer 20 among the above exemplified methods may be preferred.

Examples of the method for the above coating include a knife coating method, a roll coating method, a bar coating method, a blade coating method, a die coating method, and a gravure coating method. The composition for light diffusion control layer may be diluted using a solvent as necessary.

The above active energy rays refer to electromagnetic wave or charged particle radiation having an energy quantum, and specific examples of the active energy rays include ultraviolet rays and electron rays. Among the active energy rays, ultraviolet rays may be particularly preferred because of easy management.

When forming the previously described louver structure, a linear light source may be used as the light source for the active energy rays to irradiate the laminate surface with light randomly in the width direction (TD direction) and with approximately parallel strip-shaped (substantially linear) light in the flow direction (MD direction). The tilt angle of plate-like regions formed in the louver structure can be adjusted by adjusting the irradiation angle of the above light.

When using ultraviolet rays as the active energy rays, the irradiation condition may be preferably set such that the peak illuminance on the coating film surface is 0.1 to 200 mW/cm². Additionally or alternatively, it may be preferred to set the integrated light amount on the coating film surface to 5 to 300 mJ/cm². Additionally or alternatively, the relative moving speed of the light source for the active energy rays with respect to the above laminate may be preferably set to 0.1 to 10 m/min.

From the viewpoint of completing more reliable curing, it may also be preferred to perform irradiation with commonly-used active energy rays (active energy rays for which the process of converting the rays into strip-shaped light is not performed, scattered light) after performing the curing using the strip-shaped light as previously described. In this operation, when irradiating the coating film with active energy rays in a nitrogen atmosphere instead of attaching the second process sheet, the surface of the coating film is exposed, but from the viewpoint of uniform curing, a release sheet may be laminated on the surface of the coating film.

### (2-6) Thickness of Light Diffusion Control Layer

The thickness of the light diffusion control layer 20 may be preferably 20 μm or more, more preferably 50 μm or more, particularly preferably 80 μm or more, and further preferably 85 μm or more. When the thickness of the light diffusion control layer 20 is 20 μm or more, the desired light diffusion properties can be readily exhibited. From another aspect, the thickness of the light diffusion control layer 20 may be preferably 700 μm or less, more preferably 500 μm or less, particularly preferably 300 μm or less, further preferably 200 μm or less, especially preferably 150 μm or less, and most preferably 120 μm or less. When the thickness of the light diffusion control layer 10 is 700 μm or less, the occurrence of dents and/or collapse can be readily suppressed. Moreover, by targeting such a thickness, the light diffusion control layer 20 having no or almost no structure-unformed layer can be readily obtained.

When the light diffusion control layer 20 has a structure-unformed layer (i.e., when the thickness of the structure-unformed layer exceeds 0 μm), the upper limit of the ratio of the structure-unformed layer to the light diffusion control layer 20 may be preferably 20% or less in an embodiment, preferably 10% or less in another embodiment, preferably 5% or less in still another embodiment, or preferably 1% or less in yet another embodiment from the viewpoint of facilitating achievement of higher image sharpness. The lower limit of the ratio in this case may exceed 0%.

### 2. Third Light-Scattering Layer

The third light-scattering layer 21 in the present embodiment is not particularly limited in the configuration or composition, provided that it is a layer having light diffusion properties. From the viewpoint of easily achieving the desired light diffusion properties and making the production of the projection screen 2 easier, the third light-scattering layer 21 may be preferably a layer that contain light-diffusing fine particles, and more preferably a pressure sensitive adhesive layer that contains light-diffusing fine particles.

The pressure sensitive adhesive constituting the pressure sensitive adhesive layer is not particularly limited, provided that it does not hinder the light diffusion action of the light-diffusing fine particles, and the pressure sensitive adhesive may be preferably one having transparency. It may also be preferred that the pressure sensitive adhesive can exhibit sufficient adhesive strength to maintain the layer structure of the projection screen 2. Specific examples of the above pressure sensitive adhesive include an acrylic-based pressure sensitive adhesive, a rubber-based pressure sensitive adhesive, a silicone-based pressure sensitive adhesive, a urethane-based pressure sensitive adhesive, a polyester-based pressure sensitive adhesive, and a polyvinyl ether-based pressure sensitive adhesive. Among these, an acrylic-based pressure sensitive adhesive may be preferably used from the viewpoint of readily exhibiting the desired performance.

When the third light-scattering layer 21 is a pressure sensitive adhesive layer composed of an acrylic-based pressure sensitive adhesive, the pressure sensitive adhesive layer may be preferably formed of a pressure sensitive adhesive composition that contains at least light-diffusing fine particles, an acrylic-based polymer, and a crosslinker.

### (1) Light-Diffusing Fine Particles

The above light-diffusing fine particles are not particularly limited, but preferred examples include inorganic fine particles, organic fine particles, silicone-based fine particles composed of a silicon-containing compound with an intermediate structure between inorganic and organic structures, such as silicone resin, (e.g., TOSPEARL series available from Momentive Performance Materials Japan), and hybrid fine particles of organic resins and silicone resins. One type of the light-diffusing fine particles may be used alone or two or more types may also be used in combination.

Examples of inorganic fine particles include metal oxides such as silica, aluminum oxide, zirconium oxide, titanium oxide, zinc oxide, germanium oxide, indium oxide, tin oxide, indium tin oxide (ITO), antimony oxide, and cerium oxide; and fine particles composed of metal fluorides and the like such as magnesium fluoride and sodium fluoride. Among the above, metal oxides may be preferred, titanium oxide or zinc oxide may be particularly preferred, and titanium oxide may be further preferred. The surfaces of the inorganic fine particles may be chemically modified with an organic compound or the like.

The shape of the inorganic fine particles may be any of a definite shape such as true spherical shape, an indefinite shape, etc., but from the viewpoint of efficiently exhibiting the light-diffusing properties with a small amount, the indefinite shape may be preferred.

The inorganic fine particles in the present embodiment may be preferably so-called nanoparticles. Specifically, the average particle diameter of the inorganic fine particles may be preferably 10 to 1,000 nm, more preferably 50 to 700 nm, particularly preferably 100 to 500 nm, and further preferably 200 to 300 nm. When the average particle diameter of the inorganic fine particles is within the above range, it may be easier to achieve the desired light diffusion properties, and it may also be easier to exhibit the performance of suppressing unwanted image reflection. The average particle diameter of the inorganic fine particles is measured by a laser diffraction/scattering method.

The refractive index of the inorganic fine particles in the present embodiment may be preferably 1.8 to 3, particularly preferably 2 to 2.8, and further preferably 2.5 to 2.7. When the refractive index of the inorganic fine particles is within the above range, it may be easier to achieve the desired light diffusion properties, and it may also be easier to exhibit the performance of suppressing unwanted image reflection. The refractive index of the light-diffusing fine particles can be measured, for example, by the following method. That is, a sample is prepared through placing fine particles on a slide glass, dropping a refractive index standard solution onto the fine particles, and covering the fine particles with a cover glass. The sample is observed with a microscope, and the refractive index of the refractive index standard solution at which the outline of the fine particles becomes most difficult to see may be determined as the refractive index of the fine particles.

Examples of organic fine particles include those of acrylic resin, polystyrene resin, polyethylene resin, epoxy resin, and their copolymers or mixtures.

The shape of organic fine particles, silicone-based fine particles, and hybrid fine particles may be preferably spherical fine particles with uniform light diffusion. The average particle diameter of these fine particles measured by the centrifugal sedimentation light transmission method may be preferably 0.1 to 20 μm and more preferably 1 to 10 μm. When the average particle diameter of the above fine particles is within the above range, it may be easier to achieve the desired light diffusion properties, and it may also be easier to exhibit the performance of suppressing unwanted image reflection.

The average particle diameter measured by the centrifugal sedimentation light transmission method may be measured using centrifugal automatic particle size distribution analyzer (available from Horiba, Ltd., CAPA-700) for a sample for measurement prepared by sufficiently mixing 1.2 g of fine particles and 98.8 g of isopropyl alcohol.

When the pressure sensitive adhesive composition contains light-diffusing fine particles and an acrylic-based polymer, the content of the light-diffusing fine particles in the pressure sensitive adhesive composition may be preferably 0.01 to 5 mass parts, more preferably 0.05 to 2 mass parts, particularly preferably 0.1 to 1 mass part, and further preferably 0.2 to 0.6 mass parts with respect to 100 mass parts of the acrylic-based polymer. When the content of the light-diffusing fine particles is within the above range, it becomes easier to achieve the desired light diffusion properties, and the projection screen 2 according to the present embodiment can have more excellent visibility.

### (2) Acrylic-Based Polymer

The monomer units constituting the above acrylic-based polymer can be appropriately adjusted from the viewpoints of transparency, adhesive strength, etc., but the monomer units may preferably contain a (meth)acrylic alkyl ester and a monomer having a reactive functional group in the molecule (reactive functional group-containing monomer). In the present specification, (meth)acrylic acid means both the acrylic acid and the methacrylic acid. The same applies to other similar terms. Furthermore, the term “polymer” encompasses the concept of a “copolymer.”

The acrylic-based polymer may contain (meth)acrylic alkyl ester as a monomer unit that constitutes the polymer, and can thereby develop good pressure sensitive adhesive properties. As the (meth)acrylic alkyl ester, a (meth)acrylic alkyl ester whose carbon number of alkyl group is 1 to 20 may be preferred. The alkyl group may be linear or branched and may also have a cyclic structure.

Examples of the (meth)acrylic alkyl ester whose carbon number of alkyl group is 1 to 20 include methyl (meth)acrylate, ethyl (meth)acrylate, propyl (meth)acrylate, n-butyl (meth)acrylate, n-pentyl (meth)acrylate, n-hexyl (meth)acrylate, 2-ethylhexyl (meth)acrylate, isooctyl (meth)acrylate, n-decyl (meth)acrylate, n-dodecyl (meth)acrylate, myristyl (meth)acrylate, palmityl (meth)acrylate, stearyl (meth)acrylate, cyclohexyl (meth)acrylate, isobornyl (meth)acrylate, and adamantyl (meth)acrylate. Among these, methyl (meth)acrylate and 2-ethylhexyl (meth)acrylate may be preferred from the viewpoint of dispersibility of the previously described light-diffusing fine particles and from the viewpoint of readily achieving the desired light diffusion properties. These may each be used alone or two or more types may also be used in combination.

The above acrylic-based polymer may preferably contain 20 to 95 mass %, particularly preferably 40 to 90 mass %, and further preferably 60 to 85 mass % of the (meth)acrylic alkyl ester as a monomer unit that constitutes the polymer. Within these ranges, a desired adhesive strength can be readily achieved.

The above acrylic-based polymer may contain a reactive functional group-containing monomer as a monomer unit that constitutes the polymer. When containing a reactive functional group-containing monomer, the acrylic-based polymer reacts with a crosslinker, which will be described later, via the reactive functional group derived from the reactive functional group-containing monomer, thereby forming a crosslinked structure (three-dimensional network structure). Thus, a pressure sensitive adhesive having a desired cohesive strength can be obtained.

Preferred examples of the above reactive functional group-containing monomer include a monomer having a hydroxy group in the molecule (hydroxy group-containing monomer), a monomer having a carboxy group in the molecule (carboxy group-containing monomer), and a monomer having an amino group in the molecule (amino group-containing monomer). These reactive functional group-containing monomers may each be used alone or two or more types may also be used in combination.

Among the above reactive functional group-containing monomers, from the viewpoint of easily adjusting the crosslink density and easily obtaining a pressure sensitive adhesive having a desired cohesive strength and from the viewpoint of improving the dispersibility of the previously described light-diffusing fine particles, a hydroxy group-containing monomer or a carboxy group-containing monomer may be preferred, and from the viewpoint of adhesive strength, it is preferred to use a hydroxy group-containing monomer and a carboxy group-containing monomer in combination.

Examples of the hydroxy group-containing monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. Among the above, hydroxyalkyl (meth)acrylates whose carbon number is 1 to 4 may be preferred. Specifically, for example, 2-hydroxyethyl (meth)acrylate, 4-hydroxybutyl (meth)acrylate, etc. may be preferred, and 2-hydroxyethyl acrylate or 4-hydroxybutyl acrylate may be particularly preferred These may each be used alone or two or more types may also be used in combination.

Examples of the carboxy group-containing monomer include ethylenically unsaturated carboxylic acids such as acrylic acid, methacrylic acid, crotonic acid, maleic acid, itaconic acid, and citraconic acid. Among these, acrylic acid and methacrylic acid may be preferred from the viewpoint of the cohesive strength of a (meth)acrylic ester polymer (A) obtained. These may each be used alone or two or more types may also be used in combination.

The above acrylic-based polymer preferably contains 0.1 to 20 mass %, more preferably 0.5 to 15 mass %, and particularly preferably 0.4 to 10 mass % of the reactive functional group-containing monomer as a monomer unit that constitutes the polymer. Within these ranges, the acrylic-based polymer is more likely to undergo a desired crosslinking reaction with a crosslinked, and as a result, the obtained pressure sensitive adhesive is more likely to have good cohesive strength. Moreover, the dispersibility of the previously described light-diffusing fine particles tends to be good, and the obtained light-scattering layer can readily achieve the desired light diffusion properties.

The acrylic-based polymer in the present embodiment may further contain other monomers as monomers that constitute the polymer. Examples of the other monomers include alicyclic structure-containing (meth)acrylic esters such as dicyclopentanyl (meth)acrylate, adamantyl (meth)acrylate, isobornyl (meth)acrylate, dicyclopentenyl (meth)acrylate, and dicyclopentenyl oxyethyl (meth)acrylate; (meth)acrylic alkoxyalkyl esters such as methoxyethyl (meth)acrylate and ethoxyethyl (meth)acrylate; non-crosslinkable acrylamides such as acrylamide and methacrylamide; (meth)acrylic esters having non-crosslinkable tertiary amino groups, such as N,N-dimethylaminoethyl (meth)acrylate and N,N-dimethylaminopropyl (meth)acrylate; vinyl acetate and styrene. Among these, vinyl acetate may be preferred from the viewpoint of the cohesive strength of the (meth)acrylic ester polymer (A) obtained. These may each be used alone or two or more types may also be used in combination.

The above acrylic-based polymer may preferably contain 1 to 30 mass %, more preferably 10 to 25 mass %, and further preferably 15 to 20 mass % of other monomers as monomer units that constitute the polymer. This allows the obtained pressure sensitive adhesive to readily have good cohesive strength. Moreover, the dispersibility of the previously described light-diffusing fine particles tends to be good, and the obtained light-scattering layer can readily achieve the desired light diffusion properties.

The polymerization form of the acrylic-based polymer in the present embodiment may be a random polymer or may also be a block polymer. The acrylic-based polymer can be obtained by polymerizing any of the above-described monomers using an ordinary method. For example, the acrylic-based polymer can be prepared by polymerization, such as using an emulsion polymerization method, a solution polymerization method, a suspension polymerization method, a bulk polymerization method, or an aqueous solution polymerization method. Among these, the solution polymerization method performed in an organic solvent may be preferably adopted for preparing the acrylic-based polymer from the viewpoint of stability during polymerization and ease of handling during use.

The weight-average molecular weight of the acrylic-based polymer may be preferably 100,000 to 5,000,000, more preferably 200,000 to 2,000,000, particularly preferably 500,000 to 1,500,000, and further preferably 700,000 to aspect, the weight-average 1,000,000. From another molecular weight of the acrylic-based polymer may be preferably 2,000,000 or less, more preferably 1,500,000 or less, particularly preferably 1,000,000 or less, and further preferably 800,000 or less. This allows the acrylic-based polymer to have good dispersibility of the above-described light-diffusing fine particles, and the obtained pressure sensitive adhesive can readily exhibit the desired adhesive properties and optical properties.

The pressure sensitive adhesive composition according to the present embodiment may contain one type or two or more types of the above-described acrylic-based polymer. Additionally or alternatively, the pressure sensitive adhesive composition according to the present embodiment may contain another acrylic-based polymer together with the above-described acrylic-based polymer.

### (3) Crosslinker

Preferred aspects of the crosslinker for the third light-scattering layer 21 in the second embodiment may be the same as the content which has been described in the section “(3) Crosslinker” for the first light-scattering layer 11 and second light-scattering layer 12 in the first embodiment.

### (4) Various Additives

Preferred aspects of the various additives for the third light-scattering layer 21 in the second embodiment are the same as the content which has been described in the section “(4) Various Additives” for the first light-scattering layer 11 and second light-scattering layer 12 in the first embodiment.

### (5) Method of Preparing Pressure Sensitive Adhesive Composition

Preferred aspects of the method of preparing the pressure sensitive adhesive composition for the third light-scattering layer 21 in the second embodiment are the same as the content which has been described in the section “(5) Method of Preparing Pressure Sensitive Adhesive Composition” for the first light-scattering layer 11 and second light-scattering layer 12 in the first embodiment.

### (6) Thickness

The thickness of the third light-scattering layer 21 in the present embodiment may be preferably 1 to 200 μm, more preferably 2 to 120 μm, particularly preferably 5 to 60 μm, further preferably 10 to 30 μm, especially preferably 11 to 20 μm, and most preferably 12 to 15 μm. When the thickness of the third light-scattering layer 21 is within the above range, both the effect of suppressing the unwanted reflection and the excellent visibility can be readily achieved at a high level.

### 3. Other Configurations

The projection screen 2 according to the present embodiment may include members other than the light diffusion control layer 20 and the third light-scattering layer 21. For example, the projection screen 2 may include at least one transparent base material. In particular, when the third light-scattering layer 21 is the previously described pressure sensitive adhesive layer, a transparent base material may be preferably laminated on at least one surface of the pressure sensitive adhesive layer (in particular, the surface on the outermost layer side).

Preferred aspects of the above transparent base material are the same as the content which has been described in the section “3. Other Configurations” first embodiment.

The projection screen 2 according to the present embodiment may also include a light-transmitting member, and preferred aspects of the light-transmitting member are also the same as the content which has been described in the section “3. Other Configurations” in the first embodiment.

### 4. Method of Producing Projection Screen

The method of producing the projection screen 2 according to the present embodiment is not particularly limited. For example, the projection screen 2 can be obtained through separately forming the light diffusion control layer 20 and the third light-scattering layer 21 and then laminating the third light-scattering layer 21 and the light diffusion control layer 20.

More specific aspects such as the order regarding the above lamination and the method of forming the third light-scattering layer 21 are the same as the content which has been described in the section “4. Method of Producing Projection Screen” in the first embodiment.

### 5. Method of Using Projection Screen

Preferred methods of using the projection screen 2 according to the present embodiment are the same as the content which has been described in the section “5. Method of Using the Projection Screen” in the first embodiment.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

The embodiments heretofore explained are described to facilitate understanding of the present invention and are not described to limit the present invention. It is therefore intended that the elements disclosed in the above embodiments include all design changes and equivalents to fall within the technical scope of the present invention.

### EXAMPLES

Hereinafter, the present invention will be described further specifically with reference to examples, etc., but the scope of the present invention is not limited to these examples, etc.

### First Embodiment

### Example 1-1

### 1. Preparation of Composition for Light Diffusion Control Layer

Polyether urethane methacrylate having a weight-average molecular weight of 9,900 was obtained as a low refractive index component by reacting polypropylene glycol, isophorone diisocyanate, and 2-hydroxyethyl methacrylate. A composition for light diffusion control layer was obtained through adding 60 mass parts (solid content equivalent value, here and hereinafter) of o-phenylphenoxyethoxyethyl acrylate having a molecular weight of 268 as a high refractive index component and 8 mass parts of 2-hydroxy-2-methyl-1-phenylpropan-1-one as a photopolymerization initiator to 40 mass parts of the above low refractive index component and then heating and mixing them under a condition of 80° C.

Here, the previously described weight-average molecular weight (Mw) refers to a weight-average molecular weight that is measured as a standard polystyrene equivalent value under the following conditions using gel permeation chromatography (GPC) (GPC measurement).

### ==Measurement Conditions==

Measurement apparatus: HLC-8320 available from Tosoh Corporation
GPC columns (passing through in the following order): available from Tosoh Corporation
   TSK gel super H-H
   TSK gel super HM-H
   TSK gel super H2000
Solvent for measurement: tetrahydrofuran
Measurement temperature: 40° C.

### 2. Formation of Light Diffusion Control Layer

One surface of a long polyethylene terephthalate film (available from TOYOBO CO., LTD., product name “COSMOSHINE A4100,” thickness: 50 μm, this film may be referred to as a “first PET film (50),” hereinafter) was coated with the obtained composition for light diffusion control layer to form a coating film having a thickness of 165 μm. A laminate composed of the coating film and the first PET film (50) was thus obtained.

Subsequently, the obtained laminate was placed on a conveyor. At that time, the surface of the laminate on the coating film side was on the upper side, and the longitudinal direction of the first PET film (50) was made parallel to the flow direction of the conveyor. Then, an ultraviolet irradiation apparatus (available from EYE GRAPHICS CO., LTD., product name “ECS-4011GX”) having a linear high-pressure mercury lamp with a cold mirror for light concentration was installed on the conveyor on which the laminate was placed. This apparatus can irradiate an object with ultraviolet rays concentrated in a strip shape (approximately linear shape). Upon installation of the above ultraviolet irradiation apparatus, it was installed so that the longitudinal direction of the above high-pressure mercury lamp and the flow direction of the conveyor were orthogonal to each other.

When viewed from the longitudinal direction of the high-pressure mercury lamp, the irradiation angle of the ultraviolet rays emitted from the high-pressure mercury lamp to the laminate was set to 33° with reference to the normal line to the surface of the laminate. The irradiation angle referred to herein is described as a positive value of the acute angle formed between the normal line to the surface of the laminate and the ultraviolet rays when the ultraviolet rays are emitted toward the downstream side of the flow of the conveyor with reference to the position of the laminate just below the high-pressure mercury lamp while described as a negative value of the acute angle formed between the normal line to the surface of the laminate and the ultraviolet rays when the ultraviolet rays are emitted toward the upstream side of the flow of the conveyor.

After that, while the conveyor was operated to move the above laminate at a speed of 1.0 m/min, the coating film in the laminate was cured by being irradiated with ultraviolet rays under the conditions of a peak illuminance of 2.5 mW/cm² and an integrated light amount of 40.0 mJ/cm² on the coating film surface (this curing may be referred to as “primary curing” for convenience).

Subsequently, an easy-adhesion surface of a polyethylene terephthalate film (available from Mitsubishi Chemical Corporation, product name “PET38T600EW07,” thickness: 38 μm, this film may be referred to as a “second PET film (38),” hereinafter) provided with the easy-adhesion surface on one side was laminated on the surface of the laminate on the coating film side, and then, while the laminate was moved at a speed of 1.0 m/min, the coating film was irradiated with ultraviolet light (scattered light) through the second PET film (38) under conditions of a peak illuminance of 190 mW/cm² and an integrated light amount of 180 mJ/cm², thereby curing the coating film in the laminate (this curing may be referred to as “secondary curing” for convenience). The above-described peak illuminance and integrated light amount were measured using a UV METER (available from EYE GRAPHICS CO., LTD., product name “EYE Ultraviolet Integrated Illuminance Meter UVPF-A1”) equipped with a light receiver and installed for the position of the above coating film.

Through the above primary curing and secondary curing, the above-described coating film was sufficiently cured to form the light diffusion control layer. Thus, a laminate was obtained in which the first PET film (50), the light diffusion control layer having a thickness of 65 μm, and the second PET film (38) were laminated in this order. The thickness of the light diffusion control layer was measured using a constant-pressure thickness meter (available from Takara Seisakusho, product name “Teclock PG-02J”).

When microscopic observation and the like of the cross section of the formed light diffusion control layer were performed, it was confirmed that a louver structure was formed inside the light diffusion control layer such that a plurality of plate-like high refractive index regions were arranged in parallel at predetermined intervals. The angle on the acute angle side between the main surfaces of the louver structure and the normal line to the light diffusion control layer was 21°.

### 3. Formation of First Light-Scattering Layer and Second Light-Scattering Layer

An acrylic-based copolymer was obtained by polymerizing 67.2 mass parts of 2-ethylhexyl acrylate, 5 mass parts of methyl methacrylate, 8 mass parts of methacrylic acid, 18 mass parts of vinyl acetate, 0.4 mass parts of acrylic acid, and 1.4 mass parts of 4-hydroxybutyl acrylate by a solution polymerization method. When the weight-average molecular weight of the acrylic-based copolymer was measured by the previously described method, it was 820,000.

A coating liquid (solid content concentration 28.4 mass %) of a pressure sensitive adhesive composition was obtained by mixing in a solvent 100 mass parts (solid content equivalent value, here and hereinafter) of the obtained acrylic-based polymer, 0.47 mass parts of hexamethylene diisocyanate-based nurate (available from TOYOCHEM CO., LTD., product name “BXX6105”) as a crosslinker, and 0.5 mass parts of titanium oxide fine particles (available from Sakai Chemical Industry Co., Ltd., product name “R-62N,” average particle diameter: 0.26 μm, refractive index: 2.7) as light-diffusing fine particles.

Subsequently, an easy-adhesion surface of a polyethylene terephthalate film (available from Mitsubishi Chemical Corporation, product name “PET38T600EW07,” thickness: 38 μm, this film may be referred to as a “PET film for outermost layer,” hereinafter) provided with the easy-adhesion surface on one side was coated with the coating liquid of the pressure sensitive adhesive composition obtained as described above, and the coating liquid was dried by heating to obtain a laminate in which a pressure sensitive adhesive layer (light-scattering layer) having a thickness of 13 μm was formed on the above polyethylene terephthalate film.

Two such laminates were prepared, one of which was provided as a laminate of the first light-scattering layer and the PET film for outermost layer, and the other was provided as a laminate of the second light-scattering layer and the PET film for outermost layer.

### 4. Formation of Projection Screen

The surface on the first light-scattering layer side of the laminate, obtained in the above step 3., of the first light-scattering layer and the PET film for outermost layer was attached to the surface on the second PET film (38) side of the laminate obtained in the above step 2. Furthermore, the surface on the second light-scattering layer side of the laminate, obtained in the above step 3., of the second light-scattering layer and the PET film for outermost layer was attached to the surface on the first PET film (50) side of the laminate obtained as above.

As a result, a projection screen was obtained in which the PET film for outermost layer, the first light-scattering layer, the second PET film (38), the light diffusion control layer, the first PET film (50), the second light-scattering layer, and the PET film for outermost layer were laminated in this order.

### Comparative Example 1-1

### 1. Formation of Third Light-Scattering Layer

A coating liquid (solid content concentration 28.4 mass %) of a pressure sensitive adhesive composition was obtained by mixing in a solvent 100 mass parts of the acrylic-based polymer obtained as in step 3. of Example 1-1, 0.47 mass parts of hexamethylene diisocyanate-based nurate (available from TOYOCHEM CO., LTD., product name “BXX6105”) as a crosslinker, and 1.0 mass parts of titanium oxide fine particles (available from Sakai Chemical Industry Co., Ltd., product name “R-62N,” average particle diameter: 0.26 μm, refractive index: 2.7) as light-diffusing fine particles.

Subsequently, an easy-adhesion surface of a polyethylene terephthalate film (available from Mitsubishi Chemical Corporation, product name “PET38T600EW07,” thickness: 38 μm, PET film for outermost layer) provided with the easy-adhesion surface on one side was coated with liquid of the pressure sensitive adhesive the coating composition obtained as described above, and the coating liquid was dried by heating to obtain a laminate in which a pressure sensitive adhesive layer having a thickness of 13 μm was formed on the above polyethylene terephthalate film. In the following description, the pressure sensitive adhesive layer will be referred to as a third light-scattering layer.

### 2. Formation of Transparent Pressure Sensitive Adhesive Layer

A coating liquid (solid content concentration 28.4 mass %) of a pressure sensitive adhesive composition was obtained by mixing in a solvent 100 mass parts of the acrylic-based polymer obtained as in step 3. of Example 1-1 and 0.47 mass parts of hexamethylene diisocyanate-based nurate (available from TOYOCHEM CO., LTD., product name “BXX6105”) as a crosslinker.

Subsequently, an easy-adhesion surface of a polyethylene terephthalate film (available from Mitsubishi Chemical Corporation, product name “PET38T600EW07,” thickness: 38 μm, PET film for outermost layer) provided with the easy-adhesion surface on one side was coated with the coating liquid of the pressure sensitive adhesive composition obtained as described above, and the coating liquid was dried by heating to obtain a laminate in which a pressure sensitive adhesive layer having a thickness of 13 μm was formed on the above polyethylene terephthalate film.

Here, the above pressure sensitive adhesive layer does not contain light-diffusing fine particles and has transparency. In the following description, this pressure sensitive adhesive layer will be referred to as a transparent pressure sensitive adhesive layer.

### 3. Formation of Projection Screen

In the same manner as in step 2. of Example 1-1, a laminate was obtained in which the first PET film (50), the light diffusion control layer having a thickness of 165 μm, and the second PET film (38) were laminated in this order.

Then, the surface on the transparent pressure sensitive adhesive layer side of the laminate, obtained in the above step 2., of the transparent pressure sensitive adhesive layer and the PET film for outermost layer was attached to the surface on the first PET film (50) side of the laminate. Furthermore, the surface on the third light-scattering layer side of the laminate, obtained in the above step 1., of the third light-scattering layer and the PET film for outermost layer was attached to the surface on the second PET film (38) side of the laminate obtained as above.

As a result, a projection screen was obtained in which the PET film for outermost layer, the transparent pressure sensitive adhesive layer, the first PET film (50), the light diffusion control layer, the second PET film (38), the third light-scattering layer, and the PET film for outermost layer were laminated in this order.

### Comparative Example 1-2

In the same manner as in step 2. of Example 1-1, a laminate was obtained in which the first PET film (50), the light diffusion control layer having a thickness of 165 μm, and the second PET film (38) were laminated in this order.

Furthermore, in the same manner as in step 2. of Comparative Example 1-1, two laminates, a laminate of a transparent pressure sensitive adhesive layer and a PET film for outermost layer and another laminate of a transparent pressure sensitive adhesive layer and a PET film for outermost layer, were obtained.

Then, the surface on the transparent pressure sensitive adhesive layer side of the laminate including the transparent pressure sensitive adhesive layer was attached to the surface on the first PET film (50) side of the laminate including the light diffusion control layer. Furthermore, the surface on the transparent pressure sensitive adhesive layer side of the other laminate including the transparent pressure sensitive adhesive layer was attached to the surface on the second PET film (38) side of the laminate obtained as above.

As a result, a projection screen was obtained in which the PET film for outermost layer, the transparent pressure sensitive adhesive layer, the first PET film (50), the light diffusion control layer, the second PET film (38), the transparent pressure sensitive adhesive layer, and the PET film for outermost layer were laminated in this order.

### Reference Example 1-1

A coating liquid of a pressure sensitive adhesive composition was obtained in the same manner as in step 3. of Example 1-1. A release sheet (available from LINTEC Corporation, product name “SP-PET382150”) was prepared in which a silicone-based release agent layer was formed on one surface of a polyethylene terephthalate film having a thickness of 38 μm. The release surface of the release sheet was coated with the coating liquid, and the coating liquid was dried by heating to form a laminate in which a pressure sensitive adhesive layer (light-scattering layer) having a thickness of 13 μm was formed on the release sheet. Another such laminate was produced, resulting in a total of two such laminates.

The light-scattering layer formed as described above has the same composition (in particular, the same content of light-diffusing fine particles) as the first light-scattering layer and second light-scattering layer prepared in Example 1-1. The light-scattering layer in Reference Example 1-1 will be referred to as a “light-scattering layer A,” hereinafter.

Regarding one of the laminates obtained as described above, the surface on the light-scattering layer A side was attached to a 7 cm×15 cm float glass plate having a thickness of 2 mm. Subsequently, the release sheet was removed from the light-scattering layer A side, and the surface on the light-scattering layer A side of the other laminate was attached to the exposed surface of the light-scattering layer A.

As a result, a sample for measurement of Reference Example 1-1 was obtained in which the release sheet, the two light-scattering layers A, and the glass plate were laminated.

### Reference Example 1-2

A coating liquid of a pressure sensitive adhesive composition was obtained in the same manner as in step 1. of Comparative Example 1-1. A release sheet (available from LINTEC Corporation, name product “SP-PET382150”) was prepared in which a silicone-based release agent layer was formed on one surface of a polyethylene terephthalate film having a thickness of 38 μm. The release surface of the release sheet was coated with the coating liquid, and the coating liquid was dried by heating to form a laminate in which a pressure sensitive adhesive layer (light-scattering layer) having a thickness of 13 μm was formed on the release sheet.

The light-scattering layer formed as described above has the same composition (in particular, the same content of light-diffusing fine particles) as the third light-scattering layer prepared in Comparative Example 1-1. The light-scattering layer in Reference Example 1-2 will be referred to as a “light-scattering layer B,” hereinafter.

The surface on the light-scattering layer B side of the laminate obtained as described above was attached to a 7 cm×15 cm float glass plate having a thickness of 2 mm. As a result, a sample for measurement of Reference Example 1-2 was obtained in which the release sheet, the light-scattering layer B, and the glass plate were laminated.

### <Testing Example 1-1> (Measurement of Haze Value of Light-Scattering Layer)

Using the samples for measurement of Reference Example 1-1 and Reference Example 1-2 prepared as described above, the haze value (%) of each of the light-scattering layers A (2 layers) and the light-scattering layer B (1 layer) was measured in accordance with JIS K7136:2000 using a haze meter (available from NIPPON DENSHOKU INDUSTRIES CO., LTD., product name “NDH 7000”). Irradiation with light was performed from the release sheet side. The results are listed in Table 1. Table 1 also lists the total luminous transmittance T.T (%), the percentage of the parallel component P.T (%), and the percentage of the diffuse component Dif. (%), which were measured together with the haze value (%).

As listed in Table 1, the haze value of the light-scattering layers A (2 layers) was equivalent to the haze value of the light-scattering layer B (1 layer). From this, it can be said that the light diffusion properties are equivalent if only the light-scattering layers are taken out from the projection screens of Example 1-1 and Comparative Example 1-1 and compared.

### <Testing Example 1-2> (Measurement of Haze Value of Projection Screen)

The haze value (%) of each of the projection screens in the example and comparative examples prepared as described above was measured in accordance with JIS K7136:2000 using a haze meter (available from NIPPON DENSHOKU INDUSTRIES CO., LTD., product name “NDH 7000”). The measurement was conducted when irradiation with light was performed from the surface on the first PET film (50) side (which may be referred to as a “first PET film (50) side surface,” hereinafter) with reference to the light diffusion control layer and when irradiation with light was performed from the surface on the second PET film (38) side (which may be referred to as a “second PET film (38) side surface,” hereinafter) with reference to the light diffusion control layer.

The results are listed in Table 2. Table 2 also lists the total luminous transmittance T.T (%), the percentage of the parallel component P.T (%), and the percentage of the diffuse component Dif. (%), which were measured together with the haze value (%).

In Testing Example 1-1 in which only the light-scattering layers were compared, Reference Example 1-1 and Reference Example 1-2 exhibited similar haze values (Table 1), but the projection screens according to Example 1-1 and Comparative Example 1-1 provided with light-scattering layers equivalent to those of Reference Example 1-1 and Reference Example 1-2 resulted in a higher haze value of Example 1-1. It is presumed that such a difference is due to the fact that in Example 1-1, two light-scattering layers are arranged separately on both surfaces of the light diffusion control layer. On the other hand, the projection screen according to Comparative Example 1-2 exhibited a haze value significantly lower than those of Example 1-1 and Comparative Example 1-1. It is presumed that this reflects the fact that Comparative Example 1-2 does not have a light-scattering layer.

### <Testing Example 1-3> (Measurement of Diffusion Angle Characteristics of Projection Screen)

The projection screens prepared in the example and comparative examples were measured using a variable-angle colorimeter (available from Suga Test Instruments Co., Ltd., product name “VC-2”) for the diffusion angle characteristics of the transmitted light occurring from one surface when light rays were incident on the other surface at a predetermined angle.

Specifically, first, the standard reflective plate attached to the variable-angle colorimeter was irradiated with light rays from the C light source so that the angle between the light rays and the normal direction of the reflective surface of the standard reflective plate would be 45°, and the amount of light rays reflected in the front direction of the standard reflective plate (direction perpendicular to the reflective surface) was measured and used as a reference value.

Subsequently, light rays were emitted from the C light source onto a point (incident point) on the first PET film (50) side surface in the projection screen produced in each of the example and comparative examples so that the angle with the normal direction of the surface would be 45°. Here, the light rays were emitted so that their optical paths would be parallel to the flow direction during the production of the light diffusion control layer, and were emitted so that they would be incident on the incident point from the upstream side in the flow direction. In this case, the light rays would pass through the incident light diffusion angle region of the light diffusion control layer and would be incident on the incident point.

Then, the transmitted light occurring from the second PET film (38) side surface in the projection screen was measured by the above-described variable angle colorimeter. In this measurement, the exit angle (range of −60° to 60°) and intensity of each of the light rays that make up the transmitted light and travel parallel to the flow direction during the production of the light diffusion control layer were measured. The results are illustrated in FIG. 2. In the graph illustrated in FIG. 2, the horizontal axis represents the exit angle (°) and the vertical axis represents the light ray intensity (percentage to the above-described reference value; %).

Furthermore, on the basis of the above measurement results, the integral value (%) of the light ray intensity from an exit angle of −5° to 5° was calculated. The results are listed in Table 2.

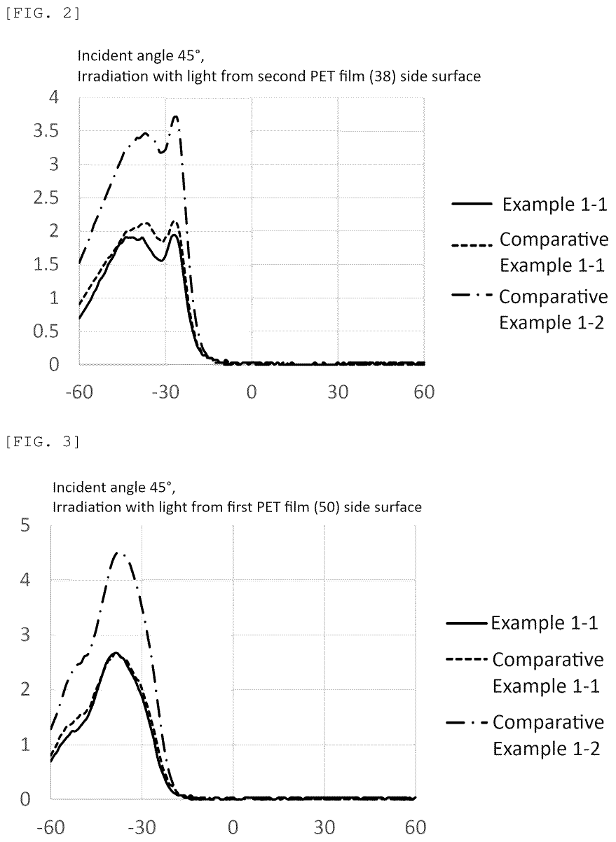

In addition, after the surface irradiated with the light rays was changed to the second PET film (38) side surface, the diffusion angle characteristics of the transmitted light were measured in the same manner as above, and the integral value (%) of the light ray intensity from an exit angle of −5° to 5° was calculated. The results are illustrated in FIG. 3 and listed in Table 2.

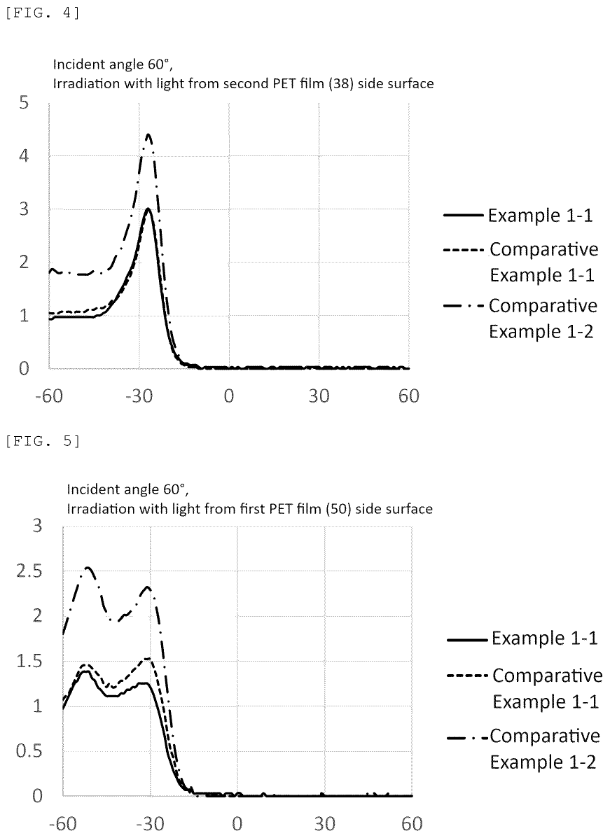

Likewise, after the incident angle of the light rays from the C light source was changed to 60°, the diffusion angle characteristics of the transmitted light were measured in the same manner as above, and the integral value (%) of the light ray intensity from an exit angle of −5° to 5° was calculated. The results are illustrated in FIG. 4 and listed in Table 2.

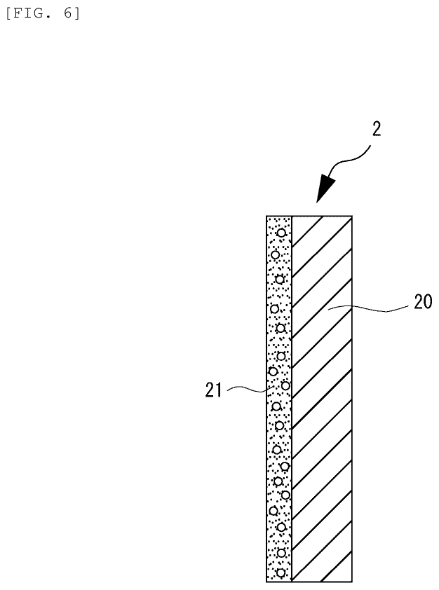

Likewise, after the incident angle of the light rays from the C light source was changed to 60° (the irradiation angle with respect to the standard reflective plate was also changed to) 60° and the surface irradiated with the light rays was changed to the second PET film (38) side surface, the diffusion angle characteristics of the transmitted light were measured in the same manner as above, and the integral value (%) of the light ray intensity from an exit angle of −5° to 5° was calculated. The results are illustrated in FIG. 5 and listed in Table 2.

TABLE 1

| | | Optical characteristics (%) | | | |
|---|---|---|---|---|---|
| | | | Total | | |
| | | | luminous | | |
| | | | transmit- | Parallel | Diffusion |
| | Layer | Haze | tance | component | component |
| | configuration | value | T.T | P.T | Dif. |
| Reference | Release | 34.5 | 79.7 | 52.2 | 27.5 |
| Example | sheet/Two | | | | |
| 1-1 | light- | | | | |
| | scattering | | | | |
| | layers A/ | | | | |
| | Glass plate | | | | |
| Reference | Release | 34.6 | 80.4 | 52.6 | 27.8 |
| Example | sheet/Light- | | | | |
| 1-2 | scattering | | | | |
| | layer B/ | | | | |
| | Glass plate | | | | |

TABLE 2

| | | Optical characteristics (%) | | | | | |
|---|---|---|---|---|---|---|---|
| | | Irradiation with light from | | | | Irradiation with light from | |
| | | second PET film (38) side surface | | | | first PET film (50) side surface | |
| | | | Total | | | | Total |
| | | | luminous | Parallel | Diffusion | | luminous |
| | | Haze | transmittance | component | component | Haze | transmittance |
| | Layer configuration | value | T.T | P.T | Dif. | value | T.T |
| Example 1-1 | PET film for outermost layer/ | 38.4 | 81.2 | 50.1 | 31.2 | 39.2 | 81.0 |
| | First light-scattering layer/ | | | | | | |
| | Second PET film (38)/ | | | | | | |
| | Light diffusion control layer/ | | | | | | |
| | First PET film (50)/ | | | | | | |
| | Second light-scattering layer/ | | | | | | |
| | PET film for outermost layer | | | | | | |
| Comparative | PET film for outermost layer/ | 36.2 | 81.3 | 51.9 | 29.4 | 36.3 | 81.4 |
| Example 1-1 | Third light-scattering layer/ | | | | | | |
| | Second PET film (38)/ | | | | | | |
| | Light diffusion control layer/ | | | | | | |
| | First PET film (50)/ | | | | | | |
| | Transparent pressure | | | | | | |
| | sensitive adhesive layer/ | | | | | | |
| | PET film for outermost | | | | | | |
| | layer control layer | | | | | | |
| Comparative | PET film for outermost layer/ | 5. [symbol] | 90.3 | [symbol] 5.3 | 5.0 | 5.1 | 90.2 |
| Example 1-2 | Transparent pressure | | | | | | |
| | sensitive adhesive layer/ | | | | | | |
| | Second PET film (38)/ | | | | | | |
| | Light diffusion control layer/ | | | | | | |
| | First PET film (50)/ | | | | | | |
| | Transparent pressure | | | | | | |
| | sensitive adhesive layer/ | | | | | | |
| | PET film for outermost. | | | | | | |
| | layer control layer | | | | | | |

| | | | Integral value (%) of light ray intensity | | | |
|---|---|---|---|---|---|---|
| | | | from exit angle of −5 [symbol] to 5 [symbol] | | | |
| | Optical characteristics (%) | | Incident angle 45° | | Incident angle 60° | |
| | Irradiation with light from | | Irradiation | Irradiation | Irradiation | Irradiation |
| | first PET film (50) side surface | | with light | with light | with light | with light |
| | Parallel | Diffusion | from second | from first | from second | from first |
| | component | component | PET film (38) | PET film (50) | PET film (38) | PET film (50) |
| | PT | Dif. | side surface | side surface | side surface | side surface |
| Example 1-1 | 49.2 | 31.8 | 0.21 | 0.15 | 0.21 | 0.15 |
| Comparative | 51.9 | 29.6 | 0.18 | 0.15 | 0 | 0 |
| Example 1-1 | | | | | | |
| Comparative | 85.5 | 4.6 | 0.06 | 0.03 | 0 | 0 |
| Example 1-2 | | | | | | |

[symbol]

indicates data missing or illegible when filed

As found from the results of “Integral value (%) of light ray intensity from exit angle of −5° to 5°” in Table 2, it can be understood that, in the projection screen produced in Example 1-1, when one surface is obliquely irradiated with light, sufficient light can be transmitted toward the other surface in the forward direction (exit angle of −5° to 5°). This indicates that a viewer who views the projection screen produced in Example 1 from the front direction can visually observe the display with a sufficient amount of light. It has thus been found that the projection screen according to Example 1-1 exhibits excellent visibility.

### Second Embodiment

### Example 2-1

### 1. Preparation of Composition for Light Diffusion Control Layer

Polyether urethane methacrylate having a weight-average molecular weight of 9,900 was obtained as a low refractive index component by reacting polypropylene glycol, isophorone diisocyanate, and 2-hydroxyethyl methacrylate. A composition for light diffusion control layer was obtained through adding 60 mass parts (solid content equivalent value, here and hereinafter) of o-phenylphenoxyethoxyethyl acrylate having a molecular weight of 268 as a high refractive index component and 8 mass parts of 2-hydroxy-2-methyl-1-phenylpropan-1-one as a photopolymerization initiator to 40 mass parts of the above low refractive index component and then heating and mixing them under a condition of 80° C.

Here, the previously described weight-average molecular weight (Mw) refers to a weight-average molecular weight that is measured as a standard polystyrene equivalent value under the following condition using gel permeation chromatography (GPC) (GPC measurement).

### ==Measurement Condition==

Measurement apparatus: HLC-8320 available from Tosoh Corporation
GPC columns (passing through in the following order): available from Tosoh Corporation
   TSK gel super H-H
   TSK gel super HM-H
   TSK gel super H2000
Solvent for measurement: tetrahydrofuran
Measurement temperature: 40° C.

### 2. Formation of Light Diffusion Control Layer

The release surface of a release sheet (available from LINTEC Corporation, product name “SP-PET381130,” thickness: 38 μm, this release sheet may be referred to as a “first release sheet”) obtained by release-treating one surface of a polyethylene terephthalate film with a silicone-based release agent was coated with the obtained composition for light diffusion control layer to form a coating film having a thickness of about 90 μm. A laminate composed of the coating film and the first release sheet was thus obtained. Subsequently, the release surface of a release sheet (available from LINTEC Corporation, product name “SP-PET381130,” thickness: 38 μm, this release sheet may be referred to as a “second release sheet”) obtained by release-treating one surface of a polyethylene terephthalate film with a silicone-based release agent was laminated on the surface of the laminate on the coating film side, and a laminate was obtained in which the first release sheet, the light diffusion control layer, and the second release sheet were laminated in this order.

Subsequently, the obtained laminate was placed on a conveyor. At that time, the surface of the second release sheet in the laminate was on the upper side, and the longitudinal direction of the first release sheet and second release sheet was made parallel to the flow direction of the conveyor. Then, an ultraviolet irradiation apparatus (available from EYE GRAPHICS CO., LTD., product name “ECS-4011GX”) having a linear high-pressure mercury lamp with a cold mirror for light concentration was installed on the conveyor on which the laminate was placed. This apparatus can irradiate an object with ultraviolet rays concentrated in a strip shape (approximately linear shape). Upon installation of the above ultraviolet irradiation apparatus, it was installed so that the longitudinal direction of the above high-pressure mercury lamp and the flow direction of the conveyor were orthogonal to each other.

When viewed from the longitudinal direction of the high-pressure mercury lamp, the irradiation angle of the ultraviolet rays emitted from the high-pressure mercury lamp to the laminate was set to 33° with reference to the normal line to the surface of the laminate. The irradiation angle referred to herein is described as a positive value of the acute angle formed between the normal line to the surface of the laminate and the ultraviolet rays when the ultraviolet rays are emitted toward the downstream side of the flow of the conveyor with reference to the position of the laminate just below the high-pressure mercury lamp while described as a negative value of the acute angle formed between the normal line to the surface of the laminate and the ultraviolet rays when the ultraviolet rays are emitted toward the upstream side of the flow of the conveyor.

After that, while the conveyor was operated to move the above laminate at a speed of 1.0 m/min, the coating film in the laminate was cured by being irradiated with ultraviolet rays through the above second release sheet under the conditions of a peak illuminance of 2.5 mW/cm² and an integrated light amount of 40.0 mJ/cm² on the coating film surface (this curing may be referred to as “primary curing” for convenience).

Subsequently, while the laminated was moved at a speed of 1.0 m/min, the coating film was irradiated with ultraviolet light (scattered light) through the second release sheet under conditions of a peak illuminance of 190 mW/cm² and an integrated light amount of 180 mJ/cm², thereby curing the coating film in the laminate (this curing may be referred to as “secondary curing” for convenience). The above-described peak illuminance and integrated light amount were measured using a UV METER (available from EYE GRAPHICS CO., LTD., name product “EYE Ultraviolet Integrated Illuminance Meter UVPF-A1”) equipped with a light receiver and installed for the position of the above coating film.

Through the above primary curing and secondary curing, the above-described coating film was sufficiently cured to form the light diffusion control layer. Thus, a laminate was obtained in which the first release sheet, the light diffusion control layer, and the second release sheet were laminated in this order.

### 3. Formation of Light-Scattering Layer

An acrylic-based copolymer was obtained by polymerizing 67.2 mass parts of 2-ethylhexyl acrylate, 5 mass parts of methyl methacrylate, 8 mass parts of methacrylic acid, 18 mass parts of vinyl acetate, 0.4 mass parts of acrylic acid, and 1.4 mass parts of 4-hydroxybutyl acrylate by a solution polymerization method. When the weight-average molecular weight of the acrylic-based copolymer was measured by the previously described method, it was 820,000.

A coating liquid (solid content concentration 28.4 mass %) of a pressure sensitive adhesive composition was obtained by mixing in a solvent 100 mass parts (solid content equivalent value, here and hereinafter) of the obtained acrylic-based polymer, 0.47 mass parts of an isocyanate-based crosslinker (available from Mitsui Chemicals, Inc., product name “TAKENATE D-165N”) as the crosslinker, and 0.5 mass parts of titanium oxide fine particles (available from Sakai Chemical Industry Co., Ltd., product name “R-62N,” average particle diameter: 0.26 μm, refractive index: 2.7) as light-diffusing fine particles.

Subsequently, an easy-adhesion surface of a polyethylene terephthalate film (available from Mitsubishi Chemical Corporation, product name “Diafoil T600E,” thickness: 38 μm, this film may be referred to as a “first PET film,” hereinafter) provided with easy-adhesion surfaces on both sides was coated with the coating liquid of the pressure sensitive adhesive composition obtained as described above, and the coating liquid was dried by heating to obtain a laminate in which a pressure sensitive adhesive layer (light-scattering layer) having a thickness of 13 μm was formed on the above first PET film.

### 4. Formation of Transparent Pressure Sensitive Adhesive Layer

A coating liquid (solid content concentration 28.4 mass %) of a pressure sensitive adhesive composition was obtained by mixing in a solvent 100 mass parts of the acrylic-based polymer obtained as in the above step 3, and 0.47 mass parts of an isocyanate-based crosslinker (available from Mitsui Chemicals, Inc., product name “TAKENATE D-165N”) as the crosslinker.

Subsequently, an easy-adhesion surface of a polyethylene terephthalate film (available from Mitsubishi Chemical Corporation, product name “Diafoil T600E,” thickness: 38 μm, this film may be referred to as a “second PET film,” hereinafter) provided with easy-adhesion surfaces on both sides was coated with the coating liquid of the pressure sensitive adhesive composition obtained as described above, and the coating liquid was dried by heating to obtain a laminate in which a transparent pressure sensitive adhesive layer having a thickness of 15 μm was formed on the above second PET film.

### 5. Formation of Projection Screen

The second release sheet of the laminate obtained in the above step 2. was removed, and the surface on the light-scattering layer side of the laminate, obtained in the above step 3., of the light-scattering layer and the first PET film was attached to the exposed surface of the light diffusion control layer exposed. Furthermore, the first release sheet of the laminate thus obtained was removed, and the surface on the transparent pressure sensitive adhesive layer side of the laminate, obtained in the above step 4., of the transparent pressure sensitive adhesive layer and the second PET film was attached to the exposed surface of the light diffusion control layer exposed.

As a result, a projection screen was obtained in which the first PET film, the light-scattering layer, the light diffusion control layer, the transparent pressure sensitive adhesive layer, and the second PET film were laminated in this order.

### Comparative Example 2-1

The release surface of a release sheet (available from LINTEC Corporation, product name “SP-PET381130,” thickness: 38 μm, this release sheet may be referred to as a “first release sheet”) obtained by release-treating one surface of a polyethylene terephthalate film with a silicone-based release agent was coated with the composition for light diffusion control layer obtained as in Example 2-1 to form a coating film having a thickness of about 160 μm. A laminate composed of the coating film and the first release sheet was thus obtained.

Subsequently, the obtained laminate was placed on a conveyor. Then, the ultraviolet irradiation apparatus installed in the same manner as in Example 1 was operated to perform irradiation with ultraviolet rays under the same conditions as in Example 1, and primary curing was performed. In this irradiation, the surface of the laminate on the coating film side was irradiated with ultraviolet rays. Subsequently, after the release surface of a release sheet (available from LINTEC Corporation, product name “SP-PET381130,” thickness: 38 μm, this release sheet may be referred to as a “second release sheet”) obtained by release-treating one surface of a polyethylene terephthalate film with a silicone-based release agent was laminated on the surface of the laminate on the coating film side, secondary curing was performed by irradiation with ultraviolet rays under the same conditions as in Example 1. In this irradiation, the coating film was irradiated with ultraviolet rays through the second release sheet.

Through the above primary curing and secondary curing, the above-described coating film was sufficiently cured to form the light diffusion control layer. Thus, a laminate was obtained in which the first release sheet, the light diffusion control layer, and the second release sheet were laminated in this order. A projection screen was obtained in the same manner as in Example 1 except that this laminate was used.

### <Testing Example 2-1> (Cross-Sectional Observation of Light Diffusion Control Layer)

The laminates with the light diffusion control layers prepared in Example 2-1 and Comparative Example 2-1 were cut using a slicer (available from JASCO Engineering CO., LTD., product name “Variable angle slicer HW-1”) to obtain slices.

Cross-sections of the obtained slices were image-captured using a digital microscope (available from KEYENCE CORPORATION, product name “VHX-1000”). The captured images are shown in FIG. 7. In FIG. 7, (A) is a cross-sectional view of Example 2-1, and (B) is a cross-sectional view of Comparative Example 2-1. The region indicated by “a” is a structure-formed layer in which a regular internal structure is formed, and the region indicated by “b” is a structure-unformed layer in which no regular internal structure is formed. As found from FIG. 7, in both the cases of Example 2-1 and Comparative Example 2-1, it was confirmed that a louver structure was formed inside the light diffusion control layer such that a plurality of plate-like high refractive index regions were arranged in parallel at predetermined intervals. The angle on the acute angle side between the main surface of the louver structure and the normal line to the light diffusion control layer was about 21°.

Furthermore, the thickness of the structure-formed layer in which a regular internal structure was formed in the light diffusion control layer and the thickness of the structure-unformed layer in which no regular internal structure was formed were measured from the captured images. The results are as listed in Table 3.

As a result of the above measurements, it has been confirmed that a structure-unformed layer is not present in the light diffusion control layer of Example 2-1. It has also been found that the light diffusion control layer of Example 2-1 has almost no difference in the thickness and internal structure as compared with Comparative Example 2-1 except that no structure-unformed layer is present.

### <Testing Example 2-2> (Evaluation of Angle Characteristics)

The haze values (%) of the projection screens prepared in the example and comparative example were measured using a variable haze meter (available from Toyo Seiki Seisaku-sho, Ltd., product name “Haze-Gard-Plus, Variable Haze Meter”).

Specifically, the surface on the first PET film side of the projection screen prepared in each of the example and comparative example was attached to one surface of an alkali-free glass plate (thickness: 1.1 mm) to obtain a laminate. Then, the laminate was installed so that the distance from the integrating sphere aperture in the above variable haze meter to the arrival position of the measurement light would be 62 mm and the alkali-free glass side would face the light source. Then, a change in the haze value (%) was measured by rotating the longitudinal direction of the projection screen (transport direction during preparation) with the width direction of the projection screen at the above arrival position as a rotation axis. That is, only the tilt angle of the projection screen was changed thereby to vary the incident angle of the measurement light with respect to the projection screen, and the haze value (%) was measured at each incident angle. Provided that the incident angle of the measurement light in the normal direction of the laminate was 0° and the rotational direction in which the traveling direction side in the longitudinal direction of the projection screen (transport direction during preparation) approached the light source gave a positive angle, the measurement was performed in a range of −70° to 70°. Details of the measurement conditions were as follows.
Light source: C light source
Measuring diameter: 018 mm
Diameter of integrating sphere aperture: 425.4 mm

The measurement results are illustrated in FIG. 8. In FIG. 8, the horizontal axis represents the incident angle, and the vertical axis represents the measured value.

Furthermore, on the basis of the above measurement results, the angles at the negative end and positive end of the incident light diffusion angle region and the width of the angle region were recorded and listed in Table 4.

As a result of the measurement, it has been found that there is no significant difference in optical properties between the light diffusion control layer of Example 2-1 and the light diffusion control layer of Comparative Example 2-1.

### <Testing Example 2-3> (Evaluation of Image Sharpness)

A test pattern was printed on one surface of a 100 μm thick polyethylene terephthalate film using an inkjet printer to prepare a printed film. A projection screen was produced in the same manner as in Example 2-1 and Comparative Example 2-1 except that the printed film was used in place of the second PET film and used via a transparent pressure sensitive adhesive layer. The projection screen was produced so that the printed surface of the printed film was in contact with the transparent pressure sensitive adhesive layer.

Subsequently, the surface of the obtained projection screen on the printed film side was attached to one surface of a mirror via a transparent pressure sensitive adhesive layer. This mirror is formed by vapor-depositing aluminum on one surface of a glass plate. The mirror and the projection screen were laminated so that the vapor-deposited surface was in contact with the transparent pressure sensitive adhesive layer. The transparent pressure sensitive adhesive layer was formed in the same manner as the transparent pressure sensitive adhesive layer provided in the previously described projection screen of Example 2-1.

As a result, a test sample was obtained in which the first PET film, the light-scattering layer, the light diffusion control layer, the transparent pressure sensitive adhesive layer, the printed film, the transparent pressure sensitive adhesive layer, and the mirror were laminated in this order.

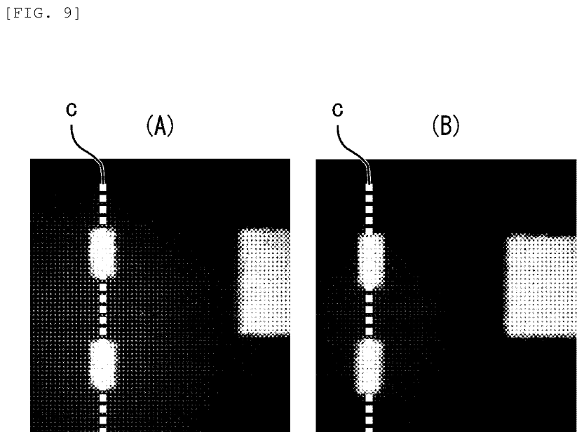

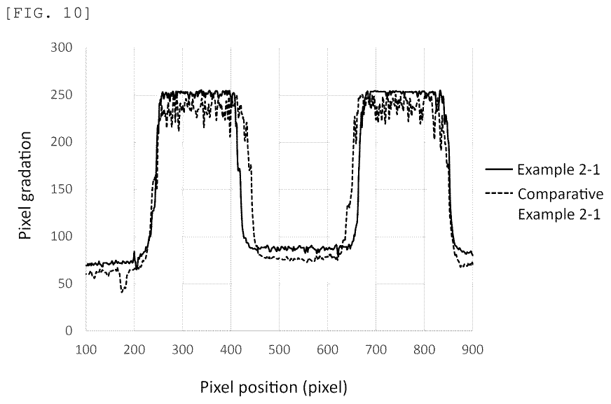

The test sample obtained as described above was irradiated with light rays from the surface on the first PET film side, and the light rays reflected by the mirror in the test sample were image-captured using a digital microscope (available from KEYENCE CORPORATION, product name “VHX-1000”). The results are illustrated in FIG. 9. In FIG. 9, (A) is an image of Example 2-1, and (B) is an image of Comparative Example 2-1.

As found from the captured images, black areas corresponding to the printed areas in the printed film and white areas corresponding to the unprinted areas were observed. The boundaries between the white and black areas were clearer in the image of Example 2-1 as compared with Comparative Example 2-1.

Furthermore, the gradations of bright and dark portions at positions of the white dashed lines marked with the symbol C in FIG. 9 were plotted on a graph with the horizontal axis representing the pixel position and the vertical axis representing the pixel gradation. The results are illustrated in FIG. 10. In the graph, the gradation of 150 or more is defined as a bright portion, and respective widths (pixels) of two bright portions are counted and listed in Table 5. Table 5 also lists the average value of these widths.

As apparent from FIG. 10 and Table 5, the width of the bright portions is wider in Comparative Example 2-1 than in Example 2-1. This indicates that light leaks into positions that should be dark portions. This leaked light leads to blurring of images. It can therefore be understood that the projection screen of Example 1 is excellent in the image sharpness as compared with Comparative Example 2-1.

### <Testing Example 2-4> (Visual Evaluation)

Light was projected obliquely from a projector onto the projection prepared in each of Example 2-1 and Comparative Example 2-1, and an image was displayed on the surface opposite to the surface onto which the light was projected. The clarity of the image was then confirmed visually. As a result, it has been confirmed that the image is displayed more clearly on the projection screen of Example 2-1 than Comparative Example 2-1.

TABLE 3

| | | | Comparative |
|---|---|---|---|
| | | Example 2-1 | Example 2-1 |
| Thickness | Structure-formed layer | 87.1 | 91.9 |
| (μm) | Structure-unformed layer | 0 | 69.2 |
| | Total | 87.1 | 161.1 |

TABLE 4

| | | Comparative |
|---|---|---|
| | Example 2-1 | Example 2-1 |
| Angle at negative end (°) | −53.30 | −57.83 |
| Angle at positive end (°) | −24.19 | −21.52 |
| Width of angle region (°) | 29.11 | 36.31 |

TABLE 5

| | | Comparative |
|---|---|---|
| | Example 2-1 | Example 2-1 |
| Width (pixels) of bright portion 1 | 177 | 205 |
| Width (pixels) of bright portion 2 | 189 | 201 |
| Average value (pixels) | 183 | 203 |

From the above test results, it has been found that the projection screen of Example 2-1 can display images with high image sharpness.

### INDUSTRIAL APPLICABILITY

The projection screen of the present invention is suitably used as a transmissive projection screen that is required to be free of unwanted image reflections.

### DESCRIPTION OF REFERENCE NUMERALS

1 . . . Projection screen
   10 . . . Light diffusion control layer
   11 . . . First light-scattering layer
   12 . . . Second light-scattering layer
2 . . . Projection screen
   20 . . . Light diffusion control layer
   21 . . . Third light-scattering layer

1. A projection screen comprising:
a first light-scattering layer;
a light diffusion control layer laminated on one surface side of the first light-scattering layer, the light diffusion control layer having a regular internal structure comprising a plurality of regions having a relatively high refractive index in a region having a relatively low refractive index; and
a second light-scattering layer laminated on a surface side of the light diffusion control layer opposite to the first light-scattering layer.

2. The projection screen according to claim 1, wherein at least one of the first light-scattering layer and the second light-scattering layer contains light-diffusing fine particles.

3. The projection screen according to claim 1, wherein its haze value is 1.0% or more and 80% or less.

4. The projection screen according to claim 1, wherein its total luminous transmittance is 60% or more and 100% or less.

5. A projection screen comprising:
a third light-scattering layer; and
a light diffusion control layer laminated on one surface side of the third light-scattering layer, the light diffusion control layer having a regular internal structure comprising a plurality of regions having a relatively high refractive index in a region having a relatively low refractive index,
wherein the light diffusion control layer includes a structure-unformed layer in which the regular internal structure is not formed, and the structure-unformed layer has a thickness of 0 μm or more and 30 μm or less.

6. The projection screen according to claim 5, wherein the third light-scattering layer contains light-diffusing fine particles.

7. The projection screen according to claim 1, wherein the regular internal structure is a louver structure configured such that a plurality of plate-like regions with different refractive indices are alternately arranged in any one direction along a sheet surface.

8. The projection screen according to claim 7, wherein the louver structure is configured such that a longitudinal direction of the plate-like regions extends horizontally when the projection screen is installed vertically to a ground surface.

9. The projection screen according to claim 1, wherein it is a transmissive projection screen.

10. The projection screen according to claim 5, wherein the regular internal structure is a louver structure configured such that a plurality of plate-like regions with different refractive indices are alternately arranged in any one direction along a sheet surface.

11. The projection screen according to claim 10, wherein the louver structure is configured such that a longitudinal direction of the plate-like regions extends horizontally when the projection screen is installed vertically to a ground surface.

12. The projection screen according to claim 5, wherein it is a transmissive projection screen.
